(19) United States
(12) Patent Application Publication
(10) Pub. No.: US 2026/0370272 A1
(43) Pub. Date: Nov. 19, 2026

(54) TECHNIQUES FOR OBTAINING SPATIAL INFORMATION WITH SPARSE ANTENNA ARRAY

(71) Applicant: QUALCOMM Incorporated, San Diego, CA (US)

(72) Inventors: Rui HU, Beijing (CN); Liangming WU, Beijing (CN); Wei XI, Beijing (CN); Hao XU, Beijing (CN)

(21) Appl. No.: 19/136,760

(22) PCT Filed: Mar. 1, 2023
(86) PCT No.: PCT/CN2023/078913

§ 371 Date: Jun. 6, 2025

(51) Int. Cl. H04B 7/0456; H04B 7/06; H04B 17/20; H04B 17/26; H04L 5/00; H04L 25/02; H04W 24/10

(52) U.S. Cl. CPC H04B 7/0456; H04B 7/0617; H04B 17/252; H04B 17/26; H04L 5/0048; H04L 25/0224; H04W 24/10

(57) ABSTRACT

Methods, systems, and devices for wireless communications are described. A user equipment (UE) may generate a spatial covariance matrix based on a set of downlink reference signals. The spatial covariance matrix may include a set of spatial lags associated with a set of antenna elements of a sparse antenna array. Each antenna element of the set of antenna elements may correspond to an antenna element index of a set of antenna element indices associated with the set of antenna elements. Each spatial lag of the set of spatial lags may correspond to a spatial lag index of a set of spatial lag indices associated with the set of antenna elements. The UE may transform the set of spatial lags based on the spatial covariance matrix, and transmit, to a network entity, a report indicating the transformed set of spatial lags associated with the set of antenna elements.

### CROSS REFERENCE

The present application is a 371 national phase filing of International PCT Application No. PCT/CN2023/078913 by HU et al., entitled “TECHNIQUES FOR OBTAINING SPATIAL INFORMATION WITH SPARSE ANTENNA ARRAY,” filed Mar. 1, 2023, which is assigned to the assignee hereof, and which is expressly incorporated by reference in its entirety herein.

### FIELD OF TECHNOLOGY

The following relates to wireless communications, including techniques for obtaining spatial information with a sparse antenna array.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for obtaining spatial information with a sparse antenna array. A user equipment (UE) may determine (e.g., measure, identify) and report spatial lag information associated with a sparse antenna array, and a network entity may extract (e.g., obtain, determine) spatial information associated with the sparse antenna array of the network entity based on the reported spatial lag information. By way of example, the UE may receive, from the network entity, a set of downlink reference signals, and perform a set of downlink reference signal measurements based on the set of downlink reference signals. The UE may generate a spatial covariance matrix based on the set of downlink reference signals, such as by determining a covariance of each downlink reference signal measurement. The spatial covariance matrix may include a set of spatial lags associated with a set of antenna elements of a sparse antenna array associated with the network entity. The UE may transform the set of spatial lags based on generating the spatial covariance matrix, and transmit, to the network entity, a report indicating the transformed set of spatial lags. And the network entity may use the set of spatial lags for or related to wireless communications associated with the UE.

A method for wireless communication at a UE is described. The method may include receiving, from a network entity, a set of downlink reference signals, generating a spatial covariance matrix based on the set of downlink reference signals, the spatial covariance matrix including a set of spatial lags associated with a set of antenna elements of a sparse antenna array associated with the network entity, each antenna element of the set of antenna elements corresponding to an antenna element index of a set of antenna element indices associated with the set of antenna elements of the sparse antenna array, and each spatial lag of the set of spatial lags corresponding to a spatial lag index of a set of spatial lag indices associated with the set of antenna elements of the sparse antenna array, transforming the set of spatial lags associated with the set of antenna elements of the sparse antenna array based on generating the spatial covariance matrix, and transmitting, to the network entity, a report indicating the transformed set of spatial lags associated with the set of antenna elements of the sparse antenna array.

An apparatus for wireless communication is described. The apparatus may include a processor, memory coupled with the processor, and instructions stored in the memory. The instructions may be executable by the processor to cause the apparatus to receive, from a network entity, a set of downlink reference signals, generate a spatial covariance matrix based on the set of downlink reference signals, the spatial covariance matrix including a set of spatial lags associated with a set of antenna elements of a sparse antenna array associated with the network entity, each antenna element of the set of antenna elements corresponding to an antenna element index of a set of antenna element indices associated with the set of antenna elements of the sparse antenna array, and each spatial lag of the set of spatial lags corresponding to a spatial lag index of a set of spatial lag indices associated with the set of antenna elements of the sparse antenna array, transform the set of spatial lags associated with the set of antenna elements of the sparse antenna array based on generating the spatial covariance matrix, and transmit, to the network entity, a report indicating the transformed set of spatial lags associated with the set of antenna elements of the sparse antenna array.

Another apparatus for wireless communication is described. The apparatus may include means for receiving, from a network entity, a set of downlink reference signals, means for generating a spatial covariance matrix based on the set of downlink reference signals, the spatial covariance matrix including a set of spatial lags associated with a set of antenna elements of a sparse antenna array associated with the network entity, each antenna element of the set of antenna elements corresponding to an antenna element index of a set of antenna element indices associated with the set of antenna elements of the sparse antenna array, and each spatial lag of the set of spatial lags corresponding to a spatial lag index of a set of spatial lag indices associated with the set of antenna elements of the sparse antenna array, means for transforming the set of spatial lags associated with the set of antenna elements of the sparse antenna array based on generating the spatial covariance matrix, and means for transmitting, to the network entity, a report indicating the transformed set of spatial lags associated with the set of antenna elements of the sparse antenna array.

A non-transitory computer-readable medium storing code for wireless communication at a UE is described. The code may include instructions executable by a processor to receive, from a network entity, a set of downlink reference signals, generate a spatial covariance matrix based on the set of downlink reference signals, the spatial covariance matrix including a set of spatial lags associated with a set of antenna elements of a sparse antenna array associated with the network entity, each antenna element of the set of antenna elements corresponding to an antenna element index of a set of antenna element indices associated with the set of antenna elements of the sparse antenna array, and each spatial lag of the set of spatial lags corresponding to a spatial lag index of a set of spatial lag indices associated with the set of antenna elements of the sparse antenna array, transform the set of spatial lags associated with the set of antenna elements of the sparse antenna array based on generating the spatial covariance matrix, and transmit, to the network entity, a report indicating the transformed set of spatial lags associated with the set of antenna elements of the sparse antenna array.

Some examples of the method, apparatuses, and non-transitory computer-readable medium described herein may further include operations, features, means, or instructions for performing a set of downlink reference signal measurements based on the set of downlink reference signals, where the set of spatial lags may be associated with the set of downlink reference signal measurements, and where generating the spatial covariance matrix may be based on the set of downlink reference signals, the set of downlink reference signal measurements, or both.

Some examples of the method, apparatuses, and non-transitory computer-readable medium described herein may further include operations, features, means, or instructions for determining a covariance of each downlink reference signal measurement of the set of downlink reference signal measurements based on performing the set of downlink reference signal measurements, where generating the spatial covariance matrix may be based on determining the covariance of each downlink reference signal measurement of the set of downlink reference signal measurements.

In some examples of the method, apparatuses, and non-transitory computer-readable medium described herein, a subset of spatial lags of the set of spatial lags correspond to a same spatial lag index of the set of spatial lag indices.

In some examples of the method, apparatuses, and non-transitory computer-readable medium described herein, transforming the set of spatial lags associated with the set of antenna elements of the sparse antenna array may include operations, features, means, or instructions for averaging the subset of spatial lags based on the subset of spatial lags of the set of spatial lags corresponding to the same spatial lag index of the set of spatial lag indices.

In some examples of the method, apparatuses, and non-transitory computer-readable medium described herein, a set of diagonal entries associated with the spatial covariance matrix corresponds to a null spatial lag index of the set of spatial lag indices.

In some examples of the method, apparatuses, and non-transitory computer-readable medium described herein, transforming the set of spatial lags associated with the set of antenna elements of the sparse antenna array may include operations, features, means, or instructions for averaging the set of diagonal entries associated with the spatial covariance matrix based on the null spatial lag index of the set of spatial lag indices.

In some examples of the method, apparatuses, and non-transitory computer-readable medium described herein, transforming the set of spatial lags associated with the set of antenna elements of the sparse antenna array may include operations, features, means, or instructions for normalizing the set of spatial lags associated with the set of antenna elements of the sparse antenna array based on a quotient of each spatial lag index of the set of spatial lag indices and a null spatial lag index of the set of spatial lag indices.

Some examples of the method, apparatuses, and non-transitory computer-readable medium described herein may further include operations, features, means, or instructions for determining the set of spatial lags associated with the set of antenna elements of the sparse antenna array based on an absolute difference between antenna element indices of the set of antenna element indices associated with the set of antenna elements of the sparse antenna array and spatial lag indices of the set of spatial lag indices associated with the set of antenna elements of the sparse antenna array, where transforming the set of spatial lags associated with the set of antenna elements of the sparse antenna array may be based on determining the set of spatial lags associated with the set of antenna elements of the sparse antenna array.

In some examples of the method, apparatuses, and non-transitory computer-readable medium described herein, the set of spatial lags associated with the set of antenna elements of the sparse antenna array includes a contiguous subset of spatial lag indices associated with the set of spatial lag indices.

Some examples of the method, apparatuses, and non-transitory computer-readable medium described herein may further include operations, features, means, or instructions for determining the contiguous subset of spatial lag indices associated with the set of spatial lag indices based on a threshold spatial lag index and on a spacing parameter associated with the spatial lag indices of the set of spatial lag indices.

In some examples of the method, apparatuses, and non-transitory computer-readable medium described herein, the report indicating the transformed set of spatial lags associated with the set of antenna elements of the sparse antenna array includes an upper triangular portion of the spatial covariance matrix.

In some examples of the method, apparatuses, and non-transitory computer-readable medium described herein, the report indicating the transformed set of spatial lags associated with the set of antenna elements of the sparse antenna array includes a lower triangular portion of the spatial covariance matrix, or the report indicating the transformed set of spatial lags associated with the set of antenna elements of the sparse antenna array includes a subset of the transformed set of spatial lags associated with the set of antenna elements of the sparse antenna array, or both.

In some examples of the method, apparatuses, and non-transitory computer-readable medium described herein, the report indicating the transformed set of spatial lags associated with the set of antenna elements of the sparse antenna array includes a subset of the transformed set of spatial lags associated with the set of antenna elements of the sparse antenna array.

Some examples of the method, apparatuses, and non-transitory computer-readable medium described herein may further include operations, features, means, or instructions for receiving, from the network entity, an indication of the set of spatial lag indices associated with the set of antenna elements of the sparse antenna array and where generating the spatial covariance matrix may be based on transmitting, to the UE, the indication of the set of spatial lag indices associated with the set of antenna elements of the sparse antenna array.

In some examples of the method, apparatuses, and non-transitory computer-readable medium described herein, the set of spatial lags associated with the set of antenna elements of the sparse antenna array corresponds to one or more dimensional coordinates associated with the sparse antenna array.

In some examples of the method, apparatuses, and non-transitory computer-readable medium described herein, the set of spatial lag indices associated with the set of antenna elements of the sparse antenna array includes a positive set of spatial lag indices.

In some examples of the method, apparatuses, and non-transitory computer-readable medium described herein, receiving, from the network entity, the set of downlink reference signals may include operations, features, means, or instructions for receiving, from the network entity, the set of downlink reference signals over a set of resource blocks, where the set of resource blocks includes a set of slots.

In some examples of the method, apparatuses, and non-transitory computer-readable medium described herein, the spatial covariance matrix includes a Hermitian matrix.

In some examples of the method, apparatuses, and non-transitory computer-readable medium described herein, the sparse antenna array may be associated with an antenna, the antenna includes an antenna polarization, and generating the spatial covariance matrix may be based on the antenna polarization.

A method for wireless communication at a network entity is described. The method may include transmitting, to a UE, a set of downlink reference signals using a set of antenna elements of a sparse antenna array associated with the network entity, each antenna element of the set of antenna elements corresponding to an antenna element index of a set of antenna element indices associated with the set of antenna elements of the sparse antenna array, receiving, from the UE, a report indicating a transformed set of spatial lags associated with the set of antenna elements of the sparse antenna array, each spatial lag of the transformed set of spatial lags corresponding to a spatial lag index of a set of spatial lag indices associated with the set of antenna elements of the sparse antenna array, determining spatial information based on the transformed set of spatial lags associated with the set of antenna elements of the sparse antenna array, and adjusting one or more parameters associated with the set of antenna elements of the sparse antenna array associated with the network entity based on determining the spatial information.

An apparatus for wireless communication is described. The apparatus may include a processor, memory coupled with the processor, and instructions stored in the memory. The instructions may be executable by the processor to cause the apparatus to transmit, to a UE, a set of downlink reference signals using a set of antenna elements of a sparse antenna array associated with the apparatus, each antenna element of the set of antenna elements corresponding to an antenna element index of a set of antenna element indices associated with the set of antenna elements of the sparse antenna array, receive, from the UE, a report indicating a transformed set of spatial lags associated with the set of antenna elements of the sparse antenna array, each spatial lag of the transformed set of spatial lags corresponding to a spatial lag index of a set of spatial lag indices associated with the set of antenna elements of the sparse antenna array, determine spatial information based on the transformed set of spatial lags associated with the set of antenna elements of the sparse antenna array, and adjust one or more parameters associated with the set of antenna elements of the sparse antenna array associated with the apparatus based on determining the spatial information.

Another apparatus for wireless communication is described. The apparatus may include means for transmitting, to a UE, a set of downlink reference signals using a set of antenna elements of a sparse antenna array associated with the apparatus, each antenna element of the set of antenna elements corresponding to an antenna element index of a set of antenna element indices associated with the set of antenna elements of the sparse antenna array, means for receiving, from the UE, a report indicating a transformed set of spatial lags associated with the set of antenna elements of the sparse antenna array, each spatial lag of the transformed set of spatial lags corresponding to a spatial lag index of a set of spatial lag indices associated with the set of antenna elements of the sparse antenna array, means for determining spatial information based on the transformed set of spatial lags associated with the set of antenna elements of the sparse antenna array, and means for adjusting one or more parameters associated with the set of antenna elements of the sparse antenna array associated with the apparatus based on determining the spatial information.

A non-transitory computer-readable medium storing code for wireless communication at a network entity is described. The code may include instructions executable by a processor to transmit, to a UE, a set of downlink reference signals using a set of antenna elements of a sparse antenna array associated with the network entity, each antenna element of the set of antenna elements corresponding to an antenna element index of a set of antenna element indices associated with the set of antenna elements of the sparse antenna array, receive, from the UE, a report indicating a transformed set of spatial lags associated with the set of antenna elements of the sparse antenna array, each spatial lag of the transformed set of spatial lags corresponding to a spatial lag index of a set of spatial lag indices associated with the set of antenna elements of the sparse antenna array, determine spatial information based on the transformed set of spatial lags associated with the set of antenna elements of the sparse antenna array, and adjust one or more parameters associated with the set of antenna elements of the sparse antenna array associated with the network entity based on determining the spatial information.

Some examples of the method, apparatuses, and non-transitory computer-readable medium described herein may further include operations, features, means, or instructions for transmitting, to the UE, an indication of the set of spatial lag indices associated with the set of antenna elements of the sparse antenna array, where receiving, from the UE, the report indicating the transformed set of spatial lags associated with the set of antenna elements of the sparse antenna array may be based on transmitting, to the UE, the indication of the set of spatial lag indices associated with the set of antenna elements of the sparse antenna array.

In some examples of the method, apparatuses, and non-transitory computer-readable medium described herein, the transformed set of spatial lags associated with the set of antenna elements of the sparse antenna array includes an averaged set of spatial lags associated with the set of antenna elements of the sparse antenna array.

In some examples of the method, apparatuses, and non-transitory computer-readable medium described herein, the transformed set of spatial lags associated with the set of antenna elements of the sparse antenna array includes a normalized set of spatial lags associated with the set of antenna elements of the sparse antenna array.

In some examples of the method, apparatuses, and non-transitory computer-readable medium described herein, the report indicating the transformed set of spatial lags associated with the set of antenna elements of the sparse antenna array includes an upper triangular portion of a spatial covariance matrix.

In some examples of the method, apparatuses, and non-transitory computer-readable medium described herein, the report indicating the transformed set of spatial lags associated with the set of antenna elements of the sparse antenna array includes a lower triangular portion of a spatial covariance matrix.

In some examples of the method, apparatuses, and non-transitory computer-readable medium described herein, the report indicating the transformed set of spatial lags associated with the set of antenna elements of the sparse antenna array includes a subset of the transformed set of spatial lags associated with the set of antenna elements of the sparse antenna array.

In some examples of the method, apparatuses, and non-transitory computer-readable medium described herein, the transformed set of spatial lags associated with the set of antenna elements of the sparse antenna array corresponds to one or more dimensional coordinates associated with the sparse antenna array.

### BRIEF DESCRIPTION OF THE DRAWINGS

FIGS. 1 and 2 illustrate examples of wireless communications systems that support techniques for obtaining spatial information with a sparse antenna array in accordance with one or more aspects of the present disclosure.

FIGS. 3 and 4 illustrate examples of spatial lag methods that support techniques for obtaining spatial information with a sparse antenna array in accordance with one or more aspects of the present disclosure.

FIG. 5 illustrates an example of a process flow that supports techniques for obtaining spatial information with a sparse antenna array in accordance with one or more aspects of the present disclosure.

FIGS. 6 and 7 illustrate block diagrams of devices that support techniques for obtaining spatial information with a sparse antenna array in accordance with one or more aspects of the present disclosure.

FIG. 8 illustrates a block diagram of a communications manager that supports techniques for obtaining spatial information with a sparse antenna array in accordance with one or more aspects of the present disclosure.

FIG. 9 illustrates a diagram of a system including a device that supports techniques for obtaining spatial information with a sparse antenna array in accordance with one or more aspects of the present disclosure.

FIGS. 10 and 11 illustrate block diagrams of devices that support techniques for obtaining spatial information with a sparse antenna array in accordance with one or more aspects of the present disclosure.

FIG. 12 illustrates a block diagram of a communications manager that supports techniques for obtaining spatial information with a sparse antenna array in accordance with one or more aspects of the present disclosure.

FIG. 13 illustrates a diagram of a system including a device that supports techniques for obtaining spatial information with a sparse antenna array in accordance with one or more aspects of the present disclosure.

FIGS. 14 and 15 illustrate flowcharts showing methods that support techniques for obtaining spatial information with a sparse antenna array in accordance with one or more aspects of the present disclosure.

### DETAILED DESCRIPTION

A user equipment (UE) may perform wireless communications via an antenna array, which may include one or more antenna elements arranged uniformly (e.g., evenly spaced) or non-uniformly (unevenly spaced). A sparse antenna array may be an example of a non-uniform antenna array, and may have a larger aperture size and spatial resolution than a uniform antenna array. The UE may estimate spatial information (e.g., angle-of-arrival (AoA), angle-of-departure (AoD)) using a sparse antenna array. For example, the UE may receive one or multiple reference signals (e.g., downlink reference signals, such as channel state information reference signal (CSI-RS)) associated with the sparse antenna array (e.g., from a network entity), and the UE may perform one or multiple measures for the one or multiple reference signals, and may report the one or multiple measurements for extracting the spatial information, for example, at the network entity, from the measurements. In some cases, the UE may report a precoding matrix indicator (PMI) for extracting the spatial information, among other information. However, the information reported by the UE, such as the PMI, may be insufficient for the network entity to determine sufficient spatial information to improve wireless communication with the UE.

Various aspects described herein relate to enabling a UE to obtain (e.g., determine, identify) and report spatial lag information associated with a sparse antenna array, and enabling a network entity to obtain (e.g., determine, identify, extract) spatial information associated with the sparse antenna array of the network entity based on the reported spatial lag information. By way of example, the UE may receive, from the network entity, a set of downlink reference signals, and perform a set of downlink reference signal measurements based on the set of downlink reference signals. The UE may generate a spatial covariance matrix based on the set of downlink reference signals. For example, the UE may determine a covariance of each downlink reference signal measurement of the set of downlink reference signal measurements, and generating the spatial covariance matrix may be based on the covariance of each downlink reference signal measurement. The spatial covariance matrix may include a set of spatial lags associated with a set of antenna elements of a sparse antenna array associated with the network entity. Each antenna element of the set of antenna elements may correspond to an antenna element index of a set of antenna element indices associated with the set of antenna elements of the sparse antenna array. Each spatial lag of the set of spatial lags may correspond to a spatial lag index of a set of spatial lag indices associated with the set of antenna elements of the sparse antenna array.

The UE may transform the set of spatial lags associated with the set of antenna elements of the sparse antenna array based on generating the spatial covariance matrix, and may transmit, to the network entity, a report indicating the transformed set of spatial lags associated with the set of antenna elements of the sparse antenna array. In some examples, transforming the set of spatial lags associated with the set of antenna elements of the sparse antenna array may include the UE performing a calculation on (e.g., averaging) a subset of spatial lags based on the subset of spatial lags of the set of spatial lags corresponding to the same spatial lag index of the set of spatial lag indices. Additionally, or alternatively, transforming the set of spatial lags associated with the set of antenna elements of the sparse antenna array may include the UE performing a calculation on (e.g., averaging) a set of diagonal entries associated with the spatial covariance matrix based on a null spatial lag index of the set of spatial lag indices. In some other examples, transforming the set of spatial lags associated with the set of antenna elements of the sparse antenna array may include the UE normalizing the set of spatial lags associated with the set of antenna elements of the sparse antenna array based on a quotient of each spatial lag index of the set of spatial lag indices and a null spatial lag index of the set of spatial lag indices.

Aspects of the disclosure are initially described in the context of wireless communications systems. Aspects of the disclosure are further illustrated by and described with reference to apparatus diagrams, system diagrams, and flowcharts that relate to techniques for obtaining spatial information with a sparse antenna array.

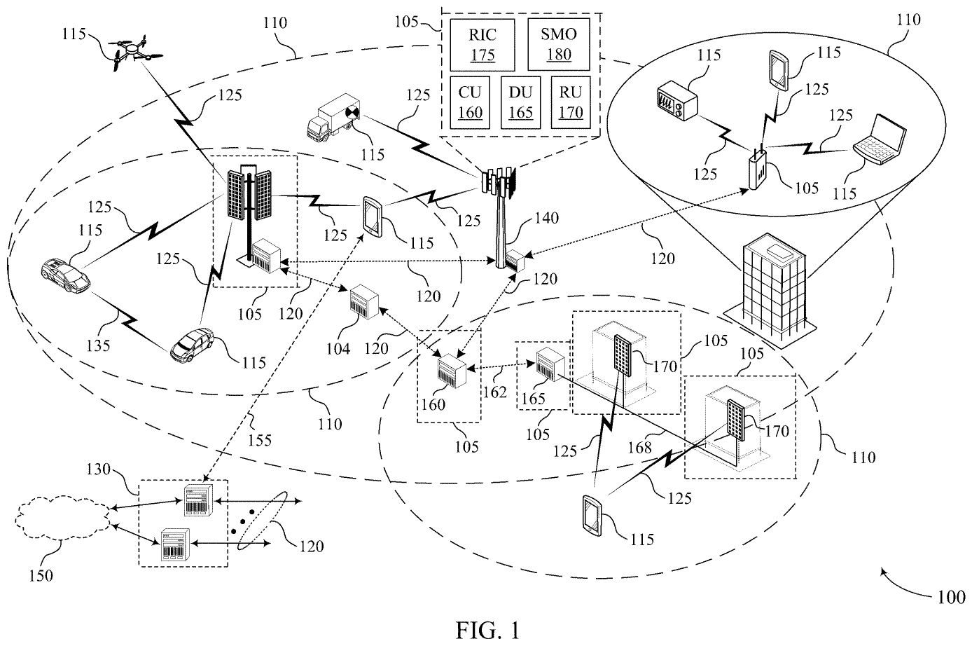

FIG. 1 illustrates an example of a wireless communications system 100 that supports techniques for obtaining spatial information with a sparse antenna array in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (LAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for obtaining spatial information with a sparse antenna array as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communications system 100, a network entity 105 may be configured with (e.g., equipped with) one or multiple antennas for transmitting to a wireless device, such as the UE 115. For example, multi antenna technologies may be advantageous due to improved spectral efficiency for communication and obtaining spatial information with high accuracy. Examples of multi antenna arrays include uniform antenna arrays (e.g., equidistance spaced antennas) and non-uniform antenna arrays (e.g., unevenly spaced antennas). A sparse antenna array (e.g., nested array, co-prime array) may be an example of a non-uniform antenna array. A sparse antenna array, for a given number of antenna elements, may achieve a larger aperture size and higher spatial resolution than a uniform array.

A sparse antenna array may be applied to NR MIMO, in the wireless communications system 100, such as to reduce power consumption (e.g., fewer radio frequency chains used) while maintaining the same aperture size, and to increase the array aperture size with fewer antenna elements (e.g., radio frequency chains). Wireless communications using non-uniform arrays may result in a larger aperture and higher spatial resolution for a given antenna number in a sparse antenna array. For a given aperture, a sparse antenna array may include fewer antennas than a uniform array, resulting in fewer radio frequency chains, and reduced power consumption. Sparse antenna arrays may be less effected by mutual coupling (MC) than uniform arrays (e.g., may experience less correlation among or between antennas of the array).

In some examples, sparse antenna arrays may be used for estimation of spatial information, such as for AoD (angle-of-departure) and AoA (angle-of-arrival) estimation. A sparse antenna array may estimate multiple AoDs and AoAs with fewer antenna elements than a uniform antenna array. For example, a network entity 105 may transmit one or more downlink reference signals via a sparse array, and the UE 115 may measure the one or more reference signals. A device may extract the AoDs from the measurements. For example, the network entity 105 may obtain spatial information by extracting the spatial information from measurements reported by the UE 115 (e.g., the AoD may be extracted from the measurements by using the Khatri-Rao multiple signal classification (KR-MUSIC) algorithm with spatial filtering). Spatial information (e.g., AoD) may be used at the network entity 105 for positioning, sensing, or other applications.

The UE 115 may calculate (e.g., obtain, determine, identify) and report a precoding matrix indicator (PMI) (e.g., for uniform arrays). For example, the UE 115 may estimate the channel, calculate precoders based on the channel estimation, and transmit a report to the network entity 105. The network entity 105 may extract the spatial information from the PMI, but the PMI may not contain sufficient information to extract all relevant spatial information. In some examples, when calculating the precoders (e.g., eigenvectors of the channel), angles of different paths may be mixed, such that some paths may not be fully described. For example, a first precoder may point to, or cover, a first path, and a second precoder may point to, or cover, a third path. The second path may be mixed into the first and second paths, and may be only partially described by the first and second precoders, which may result in inaccurate extraction. The second path may have various applications, such as for positioning, sensing, or both.

The UE 115 may report measurements of the sparse antenna array to the network entity 105 via a covariance matrix. The UE 115 may determine the covariance of the measurements of the downlink reference signals and transmit the covariance via the report to the network entity 105. The reference signals may be transmitted over a quantity of slots (T) and the UE 115 may perform (e.g., determine) a quantity of measurements (N) of the sparse antenna array. The UE 115 may create the covariance matrix R_{yyi} using the covariance of the measurements of the reference signals from the sparse antenna array on the i-th receiving antenna, as described in Equation (1).

$${R}_{{yy}_{i}} = \frac{1}{N} {\sum }_{n = 1}^{N} {y}_{n}^{i} {( {y}_{n}^{i} )}^{H} \qquad ( 1 )$$

$${y}_{n}^{i} ∈ {C}^{L} \qquad ( 2 )$$

As described in Equation (1), the covariance matrix by averaging the measurements over N (e.g., the quantity of measurements of the sparse antenna array) of the product of the two signal y terms. H represents the conjugate transpose. Equation (2) describes

$${y}_{n}^{i}$$

of Equation (1), which is the n-th measurement of the sparse antenna array, and L is the length of the sparse antenna array.

The covariance may apply to wideband, such as if the covariance is averaged across all resource blocks. In some examples, there may be Nr receiving antennas, and the UE 115 may average the covariance of all receive antennas as the matrix R_{yy} as described in Equation (3).

$${R}_{yy} = \frac{1}{N} {\sum }_{n = 1}^{N} {R}_{y {y}_{i}} \qquad ( 3 )$$

The UE 115 may report the upper or lower triangle of the matrix R_{yy}. The matrix R_{yy} may be a Hermitian matrix, such that the matrix is symmetrical and the other half of the matrix (e.g., lower or upper triangle) may be inferred. In examples of a dual-polarized antenna at the network entity 105, the UE 115 may report the covariance matrix as described in Equation (4).

$${R}_{y y}^{pol 1} and {R}_{y y}^{pol 2}$$

are the covariance matrices of the measurements form the first and second polarization, respectively.

$${R}_{y y} = {R}_{y y}^{pol 1} + {R}_{y y}^{pol 2} \qquad ( 4 )$$

The network entity 105 may extract spatial information from the reported covariance of the measurements (e.g., covariance matrix). Extracting the spatial information may offer flexibility to the network entity 105 (e.g., the network entity 105 may estimate the AoD for various resolutions), and lower complexity at the UE 115. However, the feedback payload may be large and some entries of the covariance matrix may be redundant. Techniques described herein provide for reporting the spatial lags of the measurements to reduce the feedback payload, which may apply to one dimensional or multiple dimensional arrays (e.g., both 1D and 2D arrays, among other dimensional arrays beyond 2D).

In the example of FIG. 1, a UE 115 may receive reference signals and a configuration for spatial lag indices indicating the structure of a sparse antenna array. The UE 115 may generate a spatial covariance matrix including spatial lags of the sparse antenna array based on the reference signals. The antennas of the sparse antenna array may each correspond to an antenna element index, each spatial lag may correspond to a spatial lag index, and the spatial lag indices may correspond to the antennas. Spatial lags may be the absolute difference between spatial indices. The spatial indices may be determined by either the absolute difference between antenna elements, or by the absolute difference between antenna elements with continuous, equally spaced indices. The UE 115 may transform the spatial lags, such as by averaging or normalizing. The network entity 105 may receive a report including the normalized spatial lag information, and extract the spatial information (e.g., AoD) from the report. In some examples, the sparse antenna array may include an additional dimension. Reporting normalized spatial lags may reduce feedback payload and increase accuracy of spatial information determination.

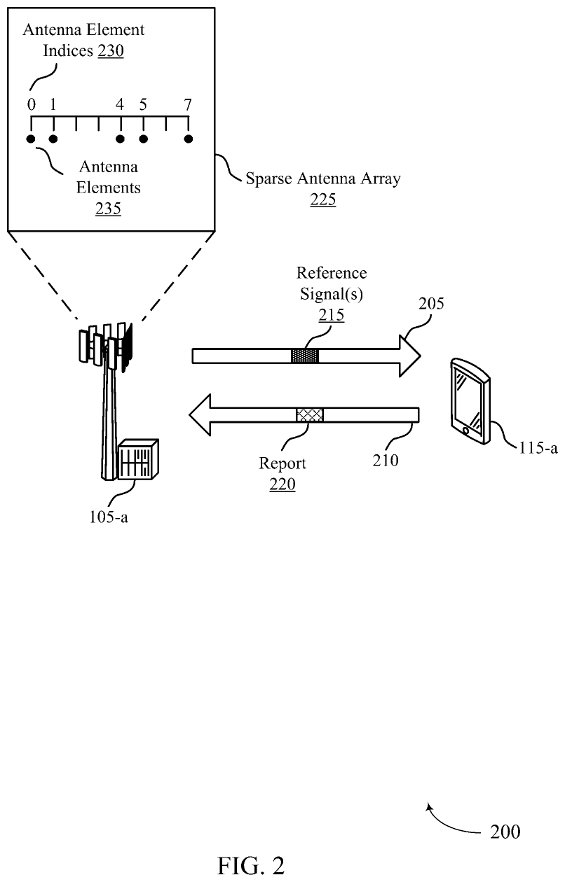

FIG. 2 illustrates an example of a wireless communications system 200 that supports techniques for obtaining spatial information with a sparse antenna array in accordance with one or more aspects of the present disclosure. The wireless communications system 200 may implement or be implemented by aspects of the wireless communications system 100 as described in FIG. 1. For example, the wireless communications system 200 may include a network entity 105-a and a UE 115-a, which may be examples of a network entity 105 and a UE 115 as described with reference to FIG. 1. The wireless communications system 200 may support multiple radio access technologies including 4G RAT such as LTE, LTE-A, or LTE-A Pro, and 5G RAT which may be referred to as NR systems, including future radio technologies, such as sixth generation (6G).

In the example of FIG. 2, The network entity 105-a may communicate (e.g., transmit, output) with the UE 115-a via a communication link 205 (e.g., a downlink channel, a physical downlink control channel (PDCCH), a physical downlink shared channel (PDSCH), among other examples). The UE 115-a may communicate (e.g., transmit, output) with the network entity 105-a via a communication link 210 (e.g., an uplink channel, a physical uplink control channel (PUCCH), a physical uplink shared channel (PUSCH), among other examples). In some cases, the network entity 105-a may communicate with the UE 115-a using a sparse antenna array 225, which may include one or more antenna elements 235 as described herein.

The network entity 105-a may transmit one or more reference signals 215 to the UE 115-a. For example, the network entity 105-a may transmit, and the UE 115-a may receive, via the communication link 205 and using the sparse antenna array 225, a set of downlink reference signals. The UE 115-a may perform a set of downlink reference signal measurements (e.g., reference signal received power (RSRP) measurements, received signal strength indicator (RSSI), reference signal received quality (RSRQ) measurements, pathloss measurements, among other examples) based on the received set of downlink reference signals. The UE 115-a may perform a transformation on the performed set of downlink reference signal measurements and transmit a report 220 to the network entity 105-a. The network entity 105-a may use the report 220 to extract spatial information (e.g., AoD). Additionally, or alternatively, the network entity 105-a may adjust one or more parameters (e.g., an adjusted transmit power, adjusted beam parameters, an adjusted AoD, or the like) associated with the set of antenna elements 235 of the sparse antenna array 225 based on the report 220 indicating the transformed set of spatial lags associated with the set of antenna elements 235 of the sparse antenna array 225.

Although illustrated with reference to a transmitting device, such as the network entity 105-a, any wireless device (e.g., a network entity 105, a UE 115, among other examples), may perform the techniques described herein or may support sparse antenna arrays. Although illustrated with reference to a sparse antenna array 225 (e.g., a linear array), sparse antenna arrays 225 may by multidimensional (e.g., including arrays or subarrays of antennas elements 235 in one or more rows or one or more columns).

The network entity 105-a may transmit the reference signals 215 via a sparse antenna array 225, which may include antenna element indices 230 and antenna elements 235. The network entity 105-a may generate downlink signaling, including reference signals 215, using one or more antenna panels. Each antenna panel may include one or more antenna elements 235, which may be organized into antenna arrays, such as the sparse antenna array 225. The antenna elements 235 may correspond to antenna element indices 230 indicating the location of the antenna elements 235. For example, sparse antenna array 225 may have the antenna elements indices 230 of 0, 1, 4, 5, and 7, indicating that the antenna elements 235 corresponding to those indices are present. Techniques described herein provide for creating and transmitting the report 220.

The UE 115-a may report, via the report 220, the spatial lags of the measurements of the reference signal 215 transmitted form the sparse antenna array 225. Spatial lag is the relative difference (e.g., absolute difference) between each antenna element 235. The spatial lag indices may be configured by the network entity 105-a based on the structure of the sparse antenna array 225. The network entity 105-a may configure a set (S) of the L-dimensional sparse antenna element indices 230. Spatial lag indices (S_{lag}) are a set of spatial lag indices that may be directly configured by the network entity 105-a or obtained from the set(S) based on different configurations.

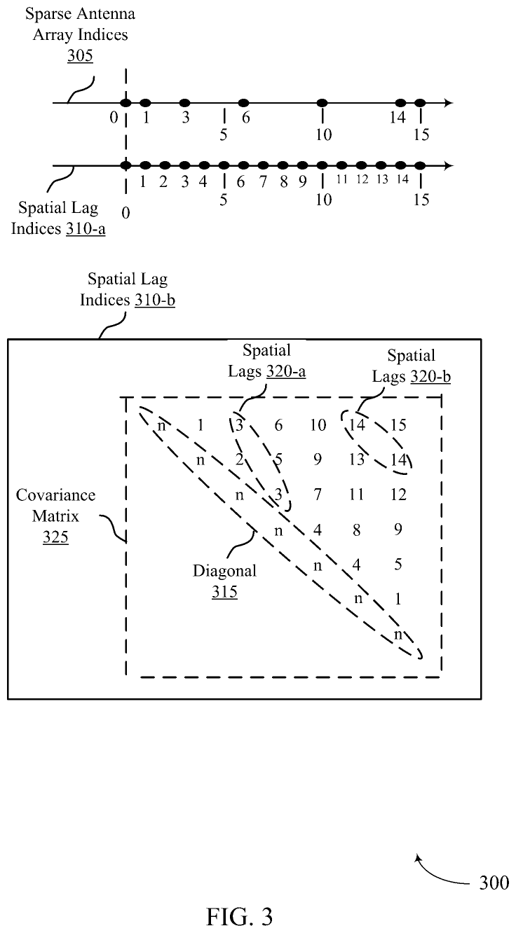

Techniques described herein include various techniques for generating spatial lag indices (S_{lag}). According to a first technique, the UE 115-a may equate the spatial lag indices to the absolute difference between spatial lag indices, further described in FIG. 3. Equation (5) describes the determination of one or more spatial lags based on the absolute differences (S_{diff}) of sparse antenna array indices(s).

S_{lag}=S_{diff}

S_{diff}={|sᵢ−sⱼ|, 1≤i,j≤L, and sᵢ,sⱼ∈S} (5)

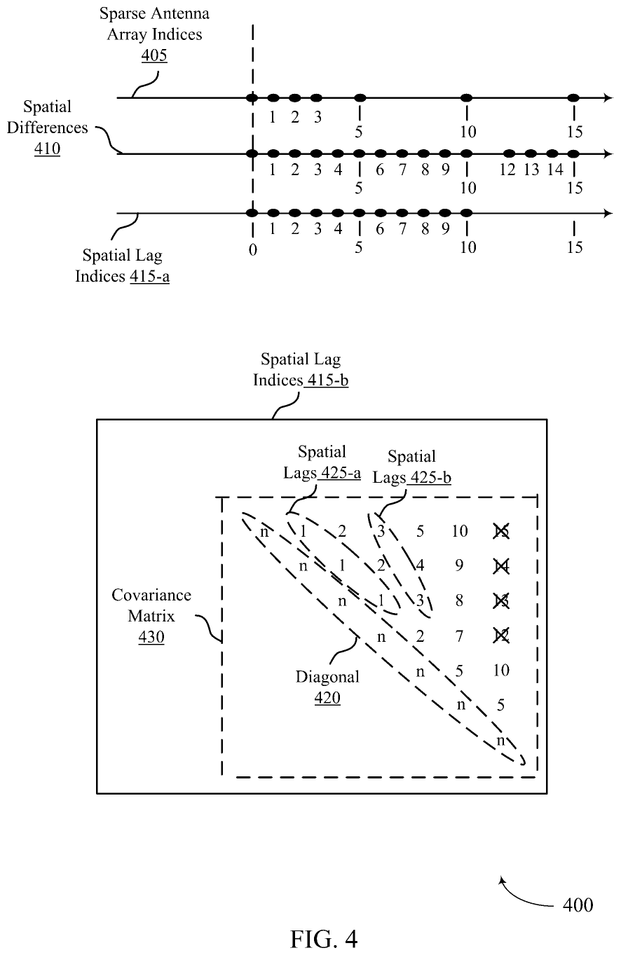

According to a second technique, the UE 115-a may equate the spatial lag to a subset of spatial lag differences with continuous and equal spacing indices, further described in FIG. 4. Equation (6) describes the determination of spatial lag where

$${S}_{diff}^{e q}$$

is a subset of

$${S}_{diff}$$

that includes continuous equally spaced indices. In some examples,

$${S}_{diff}^{e q}$$

mya be indicated by {sₘₐₓ, d}, where sₘₐₓ is the maximum index in

$${S}_{diff}^{e q}$$

and d is the spacing.

$${S}_{l a g} = {S}_{diff}^{e q} \qquad ( 6 )$$

$${S}_{diff}^{e q} = \{ {s}_{max} , d \}$$

The UE 115-a may transmit the report 220 including a report of the spatial lags of the measurements based on the spatial lag indices (S_{lag}). The spatial lags may be indicated as part of the covariance matrix including all the spatial lags.

FIG. 3 illustrates an example of a spatial lag method 300 that supports techniques for obtaining spatial information with a sparse antenna array in accordance with one or more aspects of the present disclosure. The operations of the spatial lag method 300 may be implemented by a UE 115 or its components as described herein. For example, the operations of the spatial lag method 300 may be performed by a UE 115 as described with reference to FIGS. 1 and 2. In some examples, a UE 115 may execute a set of instructions to control the functional elements of the UE 115 to perform the described functions. Additionally, or alternatively, the UE 115 may perform aspects of the described functions using special-purpose hardware.

In the example of FIG. 3, a UE 115 may determine spatial lags 320 based at least in part on spatial lag indices 310. A set of sparse antenna array indices 305 may define locations (e.g., coordinates, positions) of antenna elements of a sparse antenna array. The spatial lag indices 310 may be calculated (e.g., determined, identified) according to absolute differences between sparse antenna array indices 305. The spatial lag indices 310-a are described linearly, while the spatial lag indices 310-b are described as part of a covariance matrix 325 (e.g., matrix). The diagonal 315 may be the diagonal of the covariance matrix 325, where each entry may be a different value n. The spatial lags 320 may be the values of the covariance matrix 325 and calculated by the UE 115.

The spatial lag indices 310 (S_{lag}) may be described with reference to Equation (5), reproduced below.

S_{lag}=S_{diff}

S_{diff}={|sᵢ−sⱼ|, 1≤i,j≤L, and sᵢ,sⱼ∈S} (5)

The spatial lag indices may be equal to the spatial lag differences (S_{diff}). As described with reference to Equation (5), the spatial lag differences may be the absolute difference between the sparse antenna array indices 305, up to the L-dimension. The variable S indicates a set of sparse antenna array indices 305, and the variable s indicates one sparse antenna array index 305. For example, the sparse antenna array indices 305 may be a set S={0, 1, 3, 5, 6, 10, 14, 15}. The spatial lag indices 310 (S_{lag}) may be the set S_{lag}=S_{diff}={0, 1, 2, 3, . . . 14, 15}. Thus, by subtracting each sparse antenna array index 305 from the next, the spatial lag indices 310-a may be determined (e.g., |0−1|=1, |0−3|=3, |0−5|=5, |1−5|=4, |1−3|=2, etc.).

The UE 115 may calculate (e.g., determine) the spatial lags 320 of the measurements of the reference signal. To calculate the spatial lags 320 for reporting, the UE 115 may calculate the covariance of the measurements, extract the spatial lags 320 based on the spatial lag indices 310, and normalize the spatial lags 320 relative to the 0-th spatial lag 320.

The UE 115 may calculate (e.g., determine) the covariance of the measurements. The covariance matrix 325 R_{yy} may include all the spatial lags 320 (e.g., all the spatial lags 320 correspond to the spatial lag indices 310-b of S_{diff}). Equation (7), reproduced below, describes the covariance matrix 325. There may be multiple spatial lags 320 that correspond to the same spatial lag index 310. For example, all the L diagonal 315 entries of R_{yy} (e.g., covariance matrix 325) may correspond to the spatial lag index 310 of n.

R_{yy}∈C^{L×L} (7)

The UE 115 may extract the spatial lags 320 based on the indices of S_{lag} (e.g., the spatial lag indices 310). The UE 115 may average the multiple spatial lags 320 that correspond to the same spatial lag indices 310-b. For example, the UE 115 may add the two spatial lags 320-a (e.g., 3+3) and divide by the total number of entries (e.g., 2). In another example, the UE 115 may average the multiple spatial lags 320-b that correspond to the same spatial lag indices 310-b by adding (e.g., 14+14) and dividing by the total (e.g., 2).

The UE 115 may normalize (e.g., average, transform) the spatial lags 320 relative to the n-th spatial lag diagonal 315. For the n-th spatial lag 320, the UE 115 may average the L diagonal 315 entries in R_{yy} (e.g., covariance matrix 325). For example, the UE 115 may add all of the diagonal 315 entries and divide by the total number of entries to obtain an average spatial lag diagonal 315. The UE 115 may normalize the spatial lags 320 by dividing each spatial lag 320-a (e.g., after values with the same spatial lag indices 310-b have been averaged) by the average spatial lag diagonal 315. For example, the averaged spatial lags 320-b may be divided by the average spatial lag diagonal 315. In another example, aᵢ may be the i-the spatial lag 320, and the normalized spatial lags are aᵢ/a₀, where 0≤i≤M and M is the number of indices in S_{lag}.

The UE 115 may report the normalized spatial lags 320, where the number of coefficients reported may be M−1. For example, the total number of coefficients the UE may report of the spatial lag indices 310 is 15. For the normalized spatial lags, the n-th spatial lag is equal to 1, such that the UE 115 may not report the normalized spatial lag, and may only report the coefficients.

FIG. 4 illustrates an example of a spatial lag method 400 that supports techniques for obtaining spatial information with a sparse antenna array in accordance with one or more aspects of the present disclosure. The operations of the spatial lag method 400 may be implemented by a UE 115 or its components as described herein. For example, the operations of the spatial lag method 400 may be performed by a UE 115 as described with reference to FIGS. 1 and 2. In some examples, a UE 115 may execute a set of instructions to control the functional elements of the UE 115 to perform the described functions. Additionally, or alternatively, the UE 115 may perform aspects of the described functions using special-purpose hardware.

In the example of FIG. 4, a set of sparse antenna array indices 405 may describe the location (e.g., coordinates, position) of antenna elements of a sparse antenna array. The spatial difference 410 describes the difference in indices. The sparse antenna array indices 405 may correspond to a set of spatial lag indices 415-a. The spatial lag indices 415-b are a part of a covariance matrix 430 (e.g., matrix), in which diagonal 420 may be the diagonal of the covariance matrix 430. The spatial lags 425 may be the values of the covariance matrix 430.

The spatial lag indices 415 (S_{lag}) may be described with reference to Equation (6), reproduced below.

$${S}_{l a g} = {S}_{diff}^{e q} \qquad ( 6 )$$

$${S}_{diff}^{e q} = \{ {s}_{max} , d \}$$

The spatial lag indices 415 may be equal to a subset of spatial differences 410 (e.g., spatial lag differences) with continuous and equal spaced spatial lag indices 415. Equation (6) describes the determination of spatial lag indices 415, where

$${S}_{diff}^{e q}$$

is a subset of S_{diff} that includes continuous, equally spaced indices. In some examples,

$${S}_{diff}^{e q}$$

may be indicated by {sₘₐₓ,d}, where sₘₐₓ is the maximum index in

$${S}_{diff}^{e q}$$

and d is the spacing.

For example, the sparse antenna array indices 405 may be the set S={1, 2, 3, 4, 5, 10, 15}. The spatial differences 410 may be the set S_{diff}={0, 1, 2, . . . 10, 12, 13, 14, 15}. The spatial lag indices 415-a may be the set

$${S}_{diff}^{e q} = \{ 0 , 1 , 2 , … , 9 , 10 \} .$$

The spatial differences 410 may be calculated by subtracting each value of the sparse antenna array indices 405 (e.g., |0−1|=1, |0−2|=2, |1−5|=4, |1−10|=9, |10−15|=5, etc.). For the example described, there are no sparse antenna array indices 405 that subtract to be 11. The spatial lag indices 415 end at 10, as the following spatial lag indices 415 are not equally spaced.

The UE 115 may calculate (e.g., determine) the spatial lags 425 of the measurements of the reference signal. To calculate the spatial lags 425 for reporting, the UE 115 may calculate the covariance of the measurements, extract the spatial lags 425 based on the spatial lag indices 415, and normalize the spatial lags 425 relative to the diagonal 420 (e.g., the n-th spatial lag 425).

The UE 115 may calculate (e.g., determine) the covariance of the measurements. The covariance matrix 430 R_{yy} (e.g., Equation (7)) may include all the spatial lags 425 (e.g., all the spatial lags 425 correspond to the spatial lag indices 415-b of

$${S}_{diff}^{e q} ) .$$

There may be multiple spatial lags 425 that correspond to the same spatial lag index 415-b. For example, all the n diagonal 420 entries of R_{yy} may correspond to the same spatial lag index 415-b.

The UE 115 may extract the spatial lags 425 based on the indices of S_{lag} (e.g., the spatial lag indices 415-b). The UE 115 may average the multiple spatial lags 425 that correspond to the same spatial lag indices 415-b. For example, the UE 115 may add the two spatial lags 425-b (e.g., 3+3) and divide by the total number of entries (e.g., 2). In another example, the UE 115 may average the multiple spatial lags 425-a that correspond to the same spatial lag indices 415-b by adding the spatial lags 425-a (e.g., 1+1+1) and dividing by the total (e.g., 3).

The UE 115 may normalize (e.g., average, transform) the spatial lags 425 relative to the n-th spatial lag diagonal 420. For the n-th spatial lag index 415-b, the UE 115 may average the diagonal 420 entries in R_{yy} (e.g., up to dimension L). For example, the UE 115 may add all of the diagonal 420 entries and divide by the total number of entries to obtain an average spatial lag diagonal 420. The UE 115 may normalize the spatial lags 425 by dividing each spatial lag 425 (e.g., after values with the same spatial lag indices 415-b have been averaged) by the average spatial lag diagonal 420. For example, the UE 115 may divide the averaged spatial lags 425-a and the averaged spatial lags 425-b by the average spatial lag diagonal 420. In another example, aᵢ may be the i-the spatial lag 425, and the normalized spatial lags are aᵢ/a₀, where 0≤i≤M and M is the number of indices in S_{lag}.

The UE 115 may report the normalized spatial lags 425, where the number of coefficients report may be M−1. For example, for the spatial lag indices 415-b, the UE 115 may report 10 coefficients. For the normalized spatial lags, the n-th spatial lag is equal to 1, such that the UE 115 may not report the normalized spatial lag, and may only report the coefficients.

The covariance matrix 430 may be extended to a 2D array. For 2D arrays, the spatial lags 425 may be 2D coordinates. For example, S may be a set of the (L₁, L₂)-dimensional sparse array antenna indices. The total number of sparse antenna arrays may calculated by adding L1+L2. The spatial differences 410 may be calculated according to Equation (8).

S_{diff}={sᵢ−sⱼ, 1≤i,j≤L₁+L₂, and sᵢ,sⱼ∈S} (8)

For example, a spatial lag index 415 may be defined by two values (e.g., s₁=(0,0), s₆=(0,5), s₁₆=(5,5)). The spatial lag indices 415 (S_{lag}) may include only the positive indices in S_{diff} (the coordinates indices are all positive) or

$${S}_{diff}^{e q} .$$

For example, a sparse array may have its difference co-array (positive indices) equivalent to a full array, where each coordinate has two values of the spatial lag index 415. The UE 115 may calculate the spatial lags 425 according to the methods described herein and report, for example, to a network entity 105.

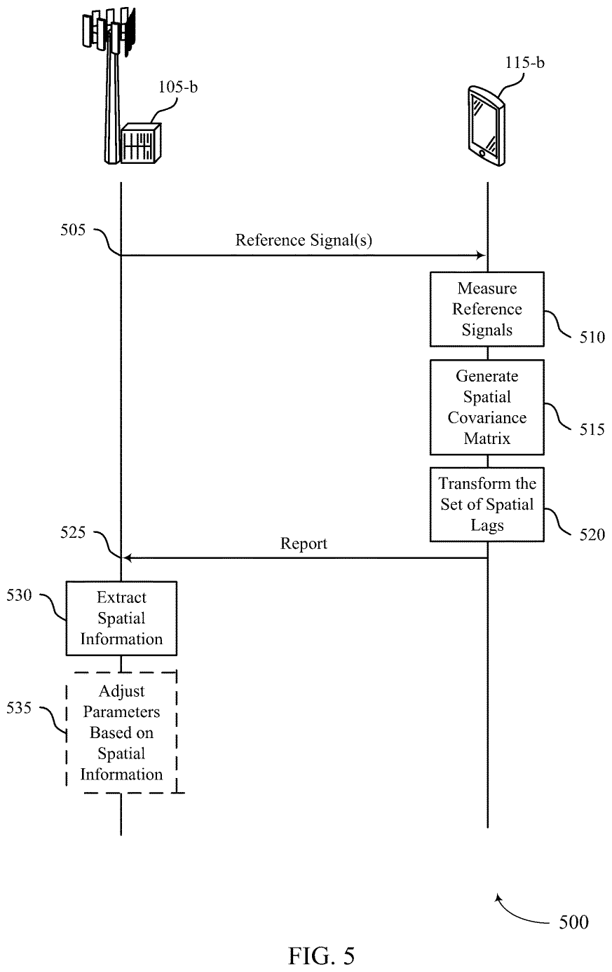

FIG. 5 illustrates an example of a process flow 500 that supports techniques for obtaining spatial information with a sparse antenna array in accordance with one or more aspects of the present disclosure. The process flow 500 may implement or be implemented by aspects of the wireless communications system 100 as described with reference to FIG. 1. For example, the process flow 500 may be implemented by a network entity 105-b and a UE 115-b, which may be an example of a network entity 105 and a UE 115 as described with reference to FIGS. 1 and 2, respectively. In the following description of the process flow 500, the operations between the network entity 105-b and the UE 115-b may be performed in different orders or at different times. Some operations may also be left out of the process flow 500, or other operations may be added.

At 505, the UE 115-b, may receive, from the network entity 105-b, a set of downlink reference signals. The set of downlink reference signals may be transmitted over a set of resource blocks, where the set of resource blocks includes a set of slots. At 510, the UE 115-b may perform a set of downlink reference signal measurements based on the set of downlink reference signals

At 515, the UE 115-b may generate a spatial covariance matrix based on the set of downlink reference signals. The spatial covariance matrix may include a set of spatial lags associated with a set of antenna elements of a sparse antenna array associated with the network entity 105-b, each antenna element of the set of antenna elements may correspond to an antenna element index of a set of antenna element indices associated with the set of antenna elements of the sparse antenna array, and each spatial lag of the set of spatial lags may correspond to a spatial lag index of a set of spatial lag indices associated with the set of antenna elements of the sparse antenna array. In some examples, the set of spatial lags may be associated with the set of downlink reference signal measurements. The UE 115-b may generate the spatial covariance matrix based on the set of downlink reference signals, the set of downlink reference signal measurements, or both.

The UE 115-b may determine a covariance of each downlink reference signal measurement of the set of downlink reference signal measurements based on performing the set of downlink reference signal measurements, where generating the spatial covariance matrix is based on determining the covariance of each downlink reference signal measurement of the set of downlink reference signal measurements.

In some examples, a subset of spatial lags of the set of spatial lags may correspond to a same spatial lag index of the set of spatial lag indices, where the set of spatial lags includes the subset of spatial lags.

In some examples, a set of diagonal entries associated with the spatial covariance matrix may corresponds to a null spatial lag index of the set of spatial lag indices. The UE 115-b may average the set of diagonal entries associated with the spatial covariance matrix based on the null spatial lag index of the set of spatial lag indices. The UE 115-b may determine the set of spatial lags associated with the set of antenna elements of the sparse antenna array based on an absolute difference between antenna element indices of the set of antenna element indices associated with the set of antenna elements of the sparse antenna array and spatial lag indices of the set of spatial lag indices associated with the set of antenna elements of the sparse antenna array.

In some examples, the set of spatial lags may be associated with the set of antenna elements of the sparse antenna array corresponding to one or more dimensional coordinates (e.g., 2D) associated with the sparse antenna array. The set of spatial lag indices may be associated with the set of antenna elements of the sparse antenna array including a positive set of spatial lag indices. In some examples, the spatial covariance matrix may be a Hermitian matrix (e.g., symmetrical). The sparse antenna array may be associated with an antenna, where the antenna includes an antenna polarization. The UE 115-b may generate the spatial covariance matrix may be based on the antenna polarization.

At 520, the UE 115-b may transform the set of spatial lags associated with the set of antenna elements of the sparse antenna array based on generating the spatial covariance matrix. The UE 115-b may transform the set of spatial lags associated with the set of antenna elements of the sparse antenna array by averaging the subset of spatial lags based on the subset of spatial lags of the set of spatial lags corresponding to the same spatial lag index of the set of spatial lag indices. Additionally, the UE may normalize the set of spatial lags associated with the set of antenna elements of the sparse antenna array based on a quotient of each spatial lag index of the set of spatial lag indices and a null spatial lag index of the set of spatial lag indices. A quotient may be a division operation by the UE. As described herein, a quotient may be a quantity produced by the division of two numbers (e.g., values). For example, the UE may normalize the set of spatial lags associated with the set of antenna elements of the sparse antenna array based on dividing a respective value of each spatial lag index of the set of spatial lag indices by a respective value of a null spatial lag index of the set of spatial lag indices. Put another way, aᵢ/a₀, where 0≤i≤M and M is the number of indices in S_{lag}.

In some examples, the UE 115-b may transform the set of spatial lags associated with the set of antenna elements of the sparse antenna array based on determining the set of spatial lags are associated with the set of antenna elements of the sparse antenna array. The set of spatial lags associated with the set of antenna elements of the sparse antenna array may include a contiguous subset of spatial lag indices associated with the set of spatial lag indices. A contiguous subset of spatial lag indices may include two or more spatial lag indices that are subsequent to each other in sequence (e.g., s_{lag(i)}, s_{lag(i+1)}, s_{lag(i+2)}, . . . ). The UE 115-b may determine the contiguous subset of spatial lag indices are associated with the set of spatial lag indices based on a threshold spatial lag index and on a spacing parameter associated with the spatial lag indices of the set of spatial lag indices.

At 525, the UE 115-b may transmit a report indicating the transformed set of spatial lags associated with the set of antenna elements of the sparse antenna array, where the transformed set of spatial lags associated with the set of antenna elements of the sparse antenna array includes an upper triangular portion of the spatial covariance matrix or a lower triangular portion of the spatial covariance matrix. The report may indicate the transformed set of spatial lags associated with the set of antenna elements of the sparse antenna array includes a subset of the transformed set of spatial lags associated with the set of antenna elements of the sparse antenna array.

At 530, the network entity 105-b may determine spatial information based on the transformed set of spatial lags associated with the set of antenna elements of the sparse antenna array. At 535, the network entity 105-b may adjust one or more parameters (e.g., transmit power, beam parameters) associated with the set of antenna elements of the sparse antenna array associated with the network entity 105-b based on determining the spatial information.

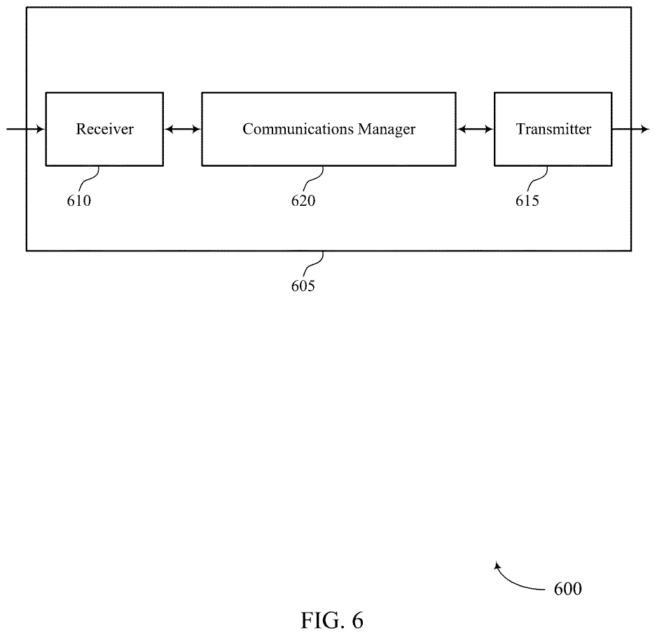

FIG. 6 illustrates a block diagram 600 of a device 605 that supports techniques for obtaining spatial information with a sparse antenna array in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for obtaining spatial information with a sparse antenna array). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for obtaining spatial information with a sparse antenna array). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for obtaining spatial information with a sparse antenna array as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE (e.g., the device 605) in accordance with examples as disclosed herein. For example, the communications manager 620 may be configured as or otherwise support a means for receiving, from a network entity, a set of downlink reference signals. The communications manager 620 may be configured as or otherwise support a means for generating a spatial covariance matrix based on the set of downlink reference signals. The spatial covariance matrix including a set of spatial lags associated with a set of antenna elements of a sparse antenna array associated with the network entity. Each antenna element of the set of antenna elements corresponding to an antenna element index of a set of antenna element indices associated with the set of antenna elements of the sparse antenna array. Each spatial lag of the set of spatial lags corresponding to a spatial lag index of a set of spatial lag indices associated with the set of antenna elements of the sparse antenna array. The communications manager 620 may be configured as or otherwise support a means for transforming the set of spatial lags associated with the set of antenna elements of the sparse antenna array based on generating the spatial covariance matrix. The communications manager 620 may be configured as or otherwise support a means for transmitting, to the network entity, a report indicating the transformed set of spatial lags associated with the set of antenna elements of the sparse antenna array.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources.

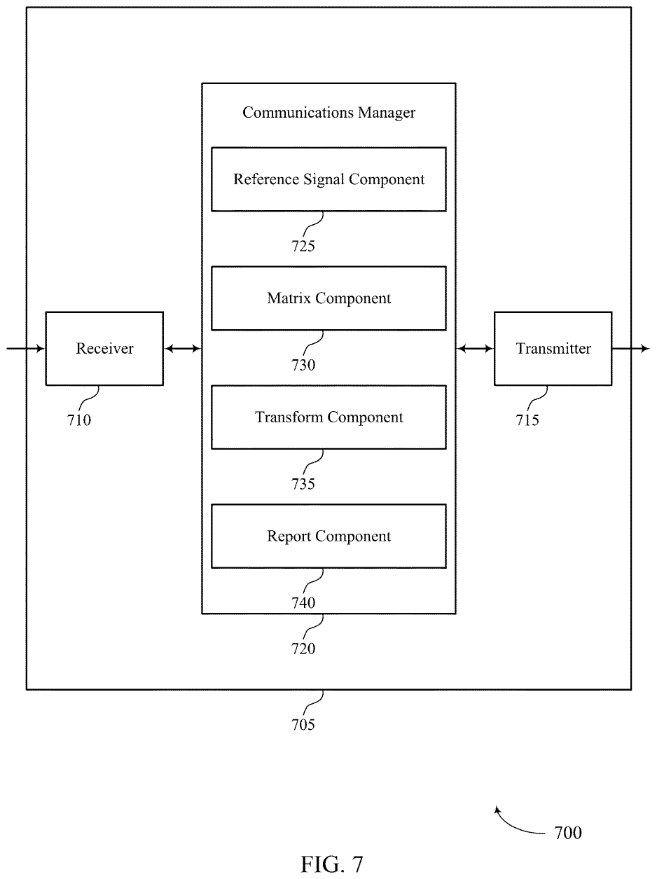

FIG. 7 illustrates a block diagram 700 of a device 705 that supports techniques for obtaining spatial information with a sparse antenna array in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for obtaining spatial information with a sparse antenna array). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for obtaining spatial information with a sparse antenna array). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for obtaining spatial information with a sparse antenna array as described herein. For example, the communications manager 720 may include a reference signal component 725, a matrix component 730, a transform component 735, a report component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE (e.g., the device 705) in accordance with examples as disclosed herein. The reference signal component 725 may be configured as or otherwise support a means for receiving, from a network entity, a set of downlink reference signals. The matrix component 730 may be configured as or otherwise support a means for generating a spatial covariance matrix based on the set of downlink reference signals. The spatial covariance matrix including a set of spatial lags associated with a set of antenna elements of a sparse antenna array associated with the network entity. Each antenna element of the set of antenna elements corresponding to an antenna element index of a set of antenna element indices associated with the set of antenna elements of the sparse antenna array. Each spatial lag of the set of spatial lags corresponding to a spatial lag index of a set of spatial lag indices associated with the set of antenna elements of the sparse antenna array. The transform component 735 may be configured as or otherwise support a means for transforming the set of spatial lags associated with the set of antenna elements of the sparse antenna array based on generating the spatial covariance matrix. The report component 740 may be configured as or otherwise support a means for transmitting, to the network entity, a report indicating the transformed set of spatial lags associated with the set of antenna elements of the sparse antenna array.

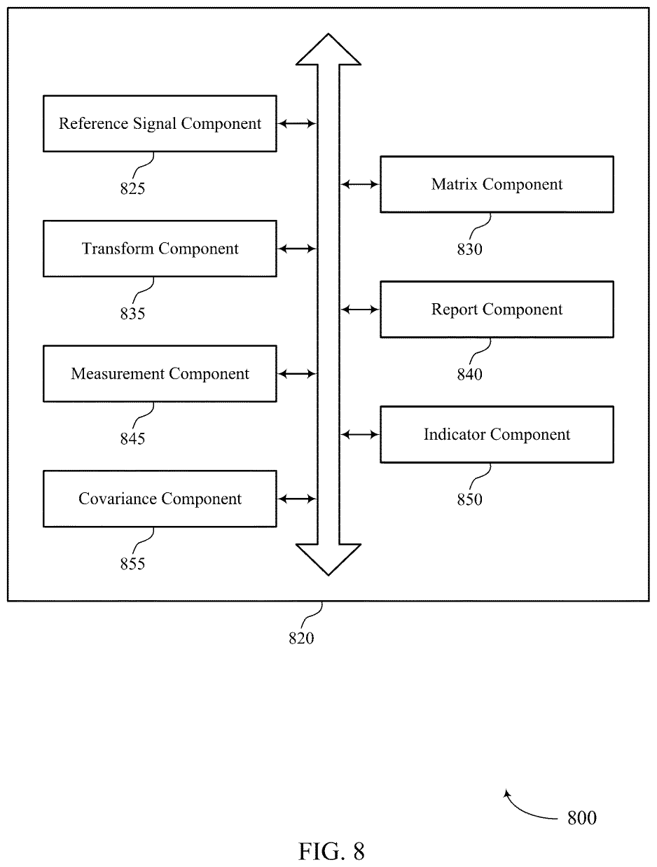

FIG. 8 illustrates a block diagram 800 of a communications manager 820 that supports techniques for obtaining spatial information with a sparse antenna array in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for obtaining spatial information with a sparse antenna array as described herein. For example, the communications manager 820 may include a reference signal component 825, a matrix component 830, a transform component 835, a report component 840, a measurement component 845, an indicator component 850, a covariance component 855, or any combination thereof. Each of these components may communicate, directly or indirectly, with one another (e.g., via one or more buses).

The communications manager 820 may support wireless communication at a UE in accordance with examples as disclosed herein. The reference signal component 825 may be configured as or otherwise support a means for receiving, from a network entity, a set of downlink reference signals. The matrix component 830 may be configured as or otherwise support a means for generating a spatial covariance matrix based on the set of downlink reference signals. The spatial covariance matrix including a set of spatial lags associated with a set of antenna elements of a sparse antenna array associated with the network entity. Each antenna element of the set of antenna elements corresponding to an antenna element index of a set of antenna element indices associated with the set of antenna elements of the sparse antenna array. Each spatial lag of the set of spatial lags corresponding to a spatial lag index of a set of spatial lag indices associated with the set of antenna elements of the sparse antenna array. The transform component 835 may be configured as or otherwise support a means for transforming the set of spatial lags associated with the set of antenna elements of the sparse antenna array based on generating the spatial covariance matrix. The report component 840 may be configured as or otherwise support a means for transmitting, to the network entity, a report indicating the transformed set of spatial lags associated with the set of antenna elements of the sparse antenna array.

In some examples, the measurement component 845 may be configured as or otherwise support a means for performing a set of downlink reference signal measurements based on the set of downlink reference signals. In some examples, the set of spatial lags are associated with the set of downlink reference signal measurements. In some examples, the matrix component 830 may be configured as or otherwise support a means for generating the spatial covariance matrix based on the set of downlink reference signals, the set of downlink reference signal measurements, or both.

In some examples, the covariance component 855 may be configured as or otherwise support a means for determining a covariance of each downlink reference signal measurement of the set of downlink reference signal measurements based on performing the set of downlink reference signal measurements. In some examples, the matrix component 830 may be configured as or otherwise support a means for generating the spatial covariance matrix based on determining the covariance of each downlink reference signal measurement of the set of downlink reference signal measurements.

In some examples, a subset of spatial lags of the set of spatial lags correspond to a same spatial lag index of the set of spatial lag indices.

In some examples, to support transforming the set of spatial lags associated with the set of antenna elements of the sparse antenna array, the transform component 835 may be configured as or otherwise support a means for averaging the subset of spatial lags based on the subset of spatial lags of the set of spatial lags corresponding to the same spatial lag index of the set of spatial lag indices.

In some examples, a set of diagonal entries associated with the spatial covariance matrix corresponds to a null spatial lag index of the set of spatial lag indices.

In some examples, to support transforming the set of spatial lags associated with the set of antenna elements of the sparse antenna array, the transform component 835 may be configured as or otherwise support a means for averaging the set of diagonal entries associated with the spatial covariance matrix based on the null spatial lag index of the set of spatial lag indices.

In some examples, to support transforming the set of spatial lags associated with the set of antenna elements of the sparse antenna array, the transform component 835 may be configured as or otherwise support a means for normalizing the set of spatial lags associated with the set of antenna elements of the sparse antenna array based on a quotient of each spatial lag index of the set of spatial lag indices and a null spatial lag index of the set of spatial lag indices.

In some examples, the matrix component 830 may be configured as or otherwise support a means for determining the set of spatial lags associated with the set of antenna elements of the sparse antenna array based on an absolute difference between antenna element indices of the set of antenna element indices associated with the set of antenna elements of the sparse antenna array and spatial lag indices of the set of spatial lag indices associated with the set of antenna elements of the sparse antenna array. In some examples, the transform component 835 may be configured as or otherwise support a means for transforming the set of spatial lags associated with the set of antenna elements of the sparse antenna array based on determining the set of spatial lags associated with the set of antenna elements of the sparse antenna array.

In some examples, the set of spatial lags associated with the set of antenna elements of the sparse antenna array includes a contiguous subset of spatial lag indices associated with the set of spatial lag indices.

In some examples, the matrix component 830 may be configured as or otherwise support a means for determining the contiguous subset of spatial lag indices associated with the set of spatial lag indices based on a threshold spatial lag index and on a spacing parameter associated with the spatial lag indices of the set of spatial lag indices.

In some examples, the report indicating the transformed set of spatial lags associated with the set of antenna elements of the sparse antenna array includes an upper triangular portion of the spatial covariance matrix.

In some examples, the report indicating the transformed set of spatial lags associated with the set of antenna elements of the sparse antenna array includes a lower triangular portion of the spatial covariance matrix, or the report indicating the transformed set of spatial lags associated with the set of antenna elements of the sparse antenna array includes a subset of the transformed set of spatial lags associated with the set of antenna elements of the sparse antenna array, or both.

In some examples, the report indicating the transformed set of spatial lags associated with the set of antenna elements of the sparse antenna array includes a subset of the transformed set of spatial lags associated with the set of antenna elements of the sparse antenna array.

In some examples, the indicator component 850 may be configured as or otherwise support a means for receiving, from the network entity, an indication of the set of spatial lag indices associated with the set of antenna elements of the sparse antenna array. In some examples, the matrix component 830 may be configured as or otherwise support a means for generating the spatial covariance matrix based on transmitting, to the UE, the indication of the set of spatial lag indices associated with the set of antenna elements of the sparse antenna array.

In some examples, the set of spatial lags associated with the set of antenna elements of the sparse antenna array corresponds to one or more dimensional coordinates associated with the sparse antenna array.

In some examples, the set of spatial lag indices associated with the set of antenna elements of the sparse antenna array includes a positive set of spatial lag indices.

In some examples, to support receiving, from the network entity, the set of downlink reference signals, the reference signal component 825 may be configured as or otherwise support a means for receiving, from the network entity, the set of downlink reference signals over a set of resource blocks, where the set of resource blocks includes a set of slots.

In some examples, the spatial covariance matrix includes a Hermitian matrix.

In some examples, the sparse antenna array is associated with an antenna. In some examples, the antenna includes an antenna polarization. In some examples, generating the spatial covariance matrix is based on the antenna polarization.

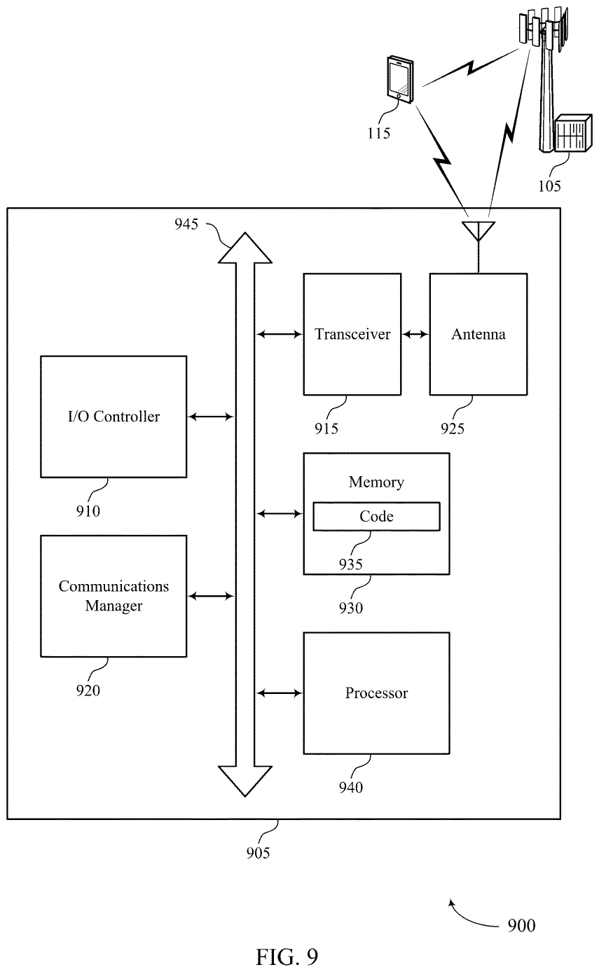

FIG. 9 illustrates a diagram of a system 900 including a device 905 that supports techniques for obtaining spatial information with a sparse antenna array in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may include, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for obtaining spatial information with a sparse antenna array). For example, the device 905 or a component of the device 905 may include a processor 940 and memory 930 coupled with or to the processor 940, the processor 940 and memory 930 configured to perform various functions described herein.

The communications manager 920 may support wireless communication at a UE (e.g., the device 905) in accordance with examples as disclosed herein. For example, the communications manager 920 may be configured as or otherwise support a means for receiving, from a network entity, a set of downlink reference signals. The communications manager 920 may be configured as or otherwise support a means for generating a spatial covariance matrix based on the set of downlink reference signals. The spatial covariance matrix including a set of spatial lags associated with a set of antenna elements of a sparse antenna array associated with the network entity. Each antenna element of the set of antenna elements corresponding to an antenna element index of a set of antenna element indices associated with the set of antenna elements of the sparse antenna array. Each spatial lag of the set of spatial lags corresponding to a spatial lag index of a set of spatial lag indices associated with the set of antenna elements of the sparse antenna array. The communications manager 920 may be configured as or otherwise support a means for transforming the set of spatial lags associated with the set of antenna elements of the sparse antenna array based on generating the spatial covariance matrix. The communications manager 920 may be configured as or otherwise support a means for transmitting, to the network entity, a report indicating the transformed set of spatial lags associated with the set of antenna elements of the sparse antenna array.

By including or configuring the communications manager 920 in accordance with examples as described herein, the device 905 may support techniques for improved communication reliability and reduced power consumption.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for obtaining spatial information with a sparse antenna array as described herein, or the processor 940 and the memory 930 may be otherwise configured to perform or support such operations.

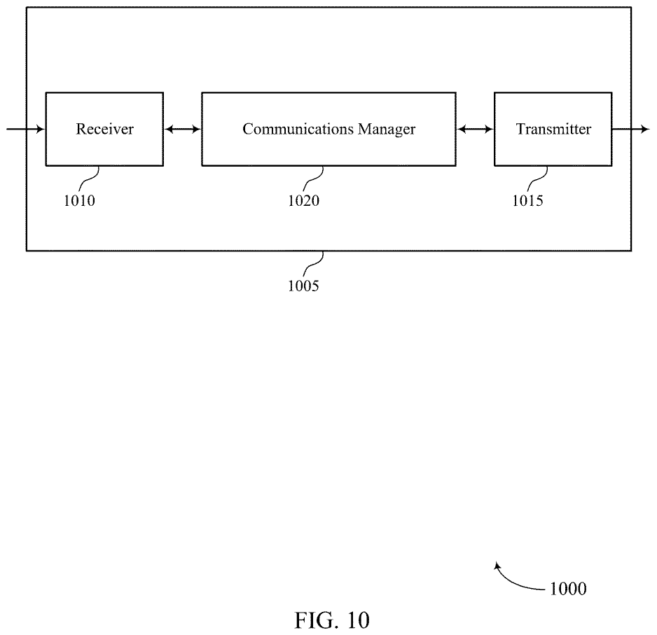

FIG. 10 illustrates a block diagram 1000 of a device 1005 that supports techniques for obtaining spatial information with a sparse antenna array in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for obtaining spatial information with a sparse antenna array as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity (e.g., the device 1005) in accordance with examples as disclosed herein. For example, the communications manager 1020 may be configured as or otherwise support a means for transmitting, to a UE, a set of downlink reference signals using a set of antenna elements of a sparse antenna array associated with the network entity, each antenna element of the set of antenna elements corresponding to an antenna element index of a set of antenna element indices associated with the set of antenna elements of the sparse antenna array. The communications manager 1020 may be configured as or otherwise support a means for receiving, from the UE, a report indicating a transformed set of spatial lags associated with the set of antenna elements of the sparse antenna array. Each spatial lag of the transformed set of spatial lags corresponding to a spatial lag index of a set of spatial lag indices associated with the set of antenna elements of the sparse antenna array. The communications manager 1020 may be configured as or otherwise support a means for determining spatial information based on the transformed set of spatial lags associated with the set of antenna elements of the sparse antenna array. The communications manager 1020 may be configured as or otherwise support a means for adjusting one or more parameters associated with the set of antenna elements of the sparse antenna array associated with the network entity based on determining the spatial information.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources.

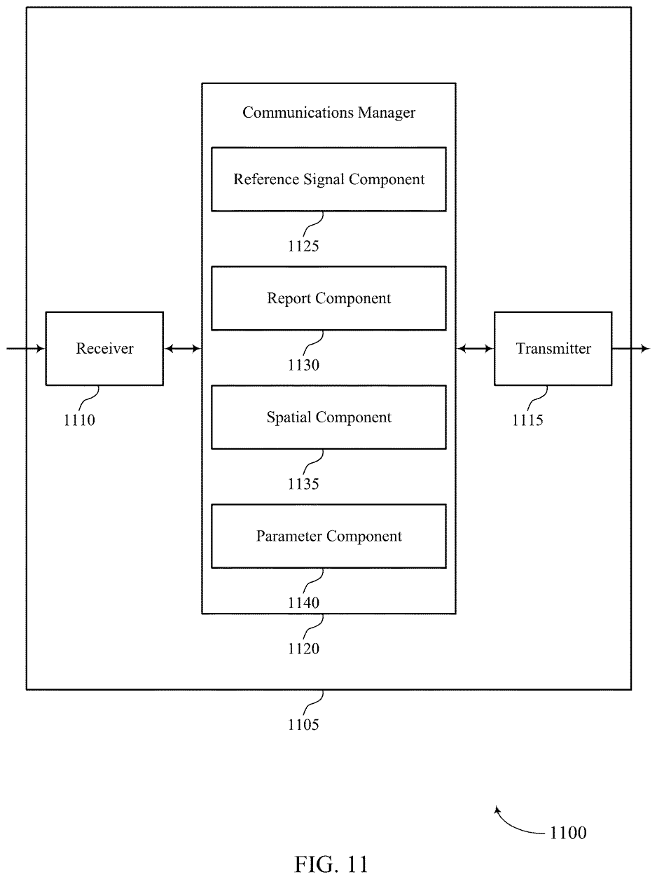

FIG. 11 illustrates a block diagram 1100 of a device 1105 that supports techniques for obtaining spatial information with a sparse antenna array in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for obtaining spatial information with a sparse antenna array as described herein. For example, the communications manager 1120 may include a reference signal component 1125, a report component 1130, a spatial component 1135, a parameter component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity (e.g., the device 1105) in accordance with examples as disclosed herein. The reference signal component 1125 may be configured as or otherwise support a means for transmitting, to a UE, a set of downlink reference signals using a set of antenna elements of a sparse antenna array associated with the network entity. Each antenna element of the set of antenna elements corresponding to an antenna element index of a set of antenna element indices associated with the set of antenna elements of the sparse antenna array. The report component 1130 may be configured as or otherwise support a means for receiving, from the UE, a report indicating a transformed set of spatial lags associated with the set of antenna elements of the sparse antenna array. Each spatial lag of the transformed set of spatial lags corresponding to a spatial lag index of a set of spatial lag indices associated with the set of antenna elements of the sparse antenna array. The spatial component 1135 may be configured as or otherwise support a means for determining spatial information based on the transformed set of spatial lags associated with the set of antenna elements of the sparse antenna array. The parameter component 1140 may be configured as or otherwise support a means for adjusting one or more parameters associated with the set of antenna elements of the sparse antenna array associated with the network entity based on determining the spatial information.

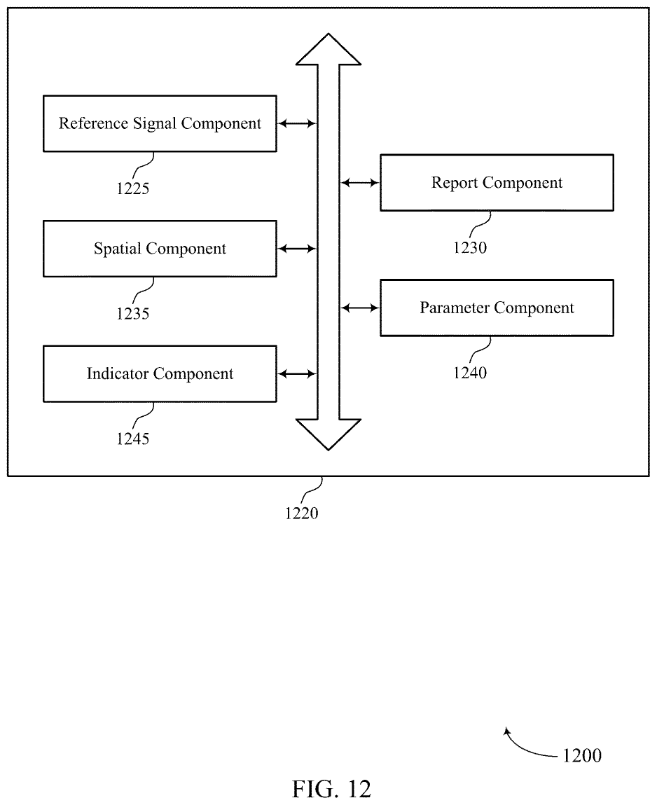

FIG. 12 illustrates a block diagram 1200 of a communications manager 1220 that supports techniques for obtaining spatial information with a sparse antenna array in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for obtaining spatial information with a sparse antenna array as described herein. For example, the communications manager 1220 may include a reference signal component 1225, a report component 1230, a spatial component 1235, a parameter component 1240, an indicator component 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The reference signal component 1225 may be configured as or otherwise support a means for transmitting, to a UE, a set of downlink reference signals using a set of antenna elements of a sparse antenna array associated with the network entity. Each antenna element of the set of antenna elements corresponding to an antenna element index of a set of antenna element indices associated with the set of antenna elements of the sparse antenna array. The report component 1230 may be configured as or otherwise support a means for receiving, from the UE, a report indicating a transformed set of spatial lags associated with the set of antenna elements of the sparse antenna array. Each spatial lag of the transformed set of spatial lags corresponding to a spatial lag index of a set of spatial lag indices associated with the set of antenna elements of the sparse antenna array. The spatial component 1235 may be configured as or otherwise support a means for determining spatial information based on the transformed set of spatial lags associated with the set of antenna elements of the sparse antenna array. The parameter component 1240 may be configured as or otherwise support a means for adjusting one or more parameters associated with the set of antenna elements of the sparse antenna array associated with the network entity based on determining the spatial information.

In some examples, the indicator component 1245 may be configured as or otherwise support a means for transmitting, to the UE, an indication of the set of spatial lag indices associated with the set of antenna elements of the sparse antenna array. In some examples, the report component 1230 may be configured as or otherwise support a means for receiving, from the UE, the report indicating the transformed set of spatial lags associated with the set of antenna elements of the sparse antenna array based on transmitting, to the UE, the indication of the set of spatial lag indices associated with the set of antenna elements of the sparse antenna array.

In some examples, the transformed set of spatial lags associated with the set of antenna elements of the sparse antenna array includes an averaged set of spatial lags associated with the set of antenna elements of the sparse antenna array.

In some examples, the transformed set of spatial lags associated with the set of antenna elements of the sparse antenna array includes a normalized set of spatial lags associated with the set of antenna elements of the sparse antenna array.

In some examples, the report indicating the transformed set of spatial lags associated with the set of antenna elements of the sparse antenna array includes an upper triangular portion of a spatial covariance matrix.

In some examples, the report indicating the transformed set of spatial lags associated with the set of antenna elements of the sparse antenna array includes a lower triangular portion of a spatial covariance matrix.

In some examples, the report indicating the transformed set of spatial lags associated with the set of antenna elements of the sparse antenna array includes a subset of the transformed set of spatial lags associated with the set of antenna elements of the sparse antenna array.

In some examples, the transformed set of spatial lags associated with the set of antenna elements of the sparse antenna array corresponds to one or more dimensional coordinates associated with the sparse antenna array.

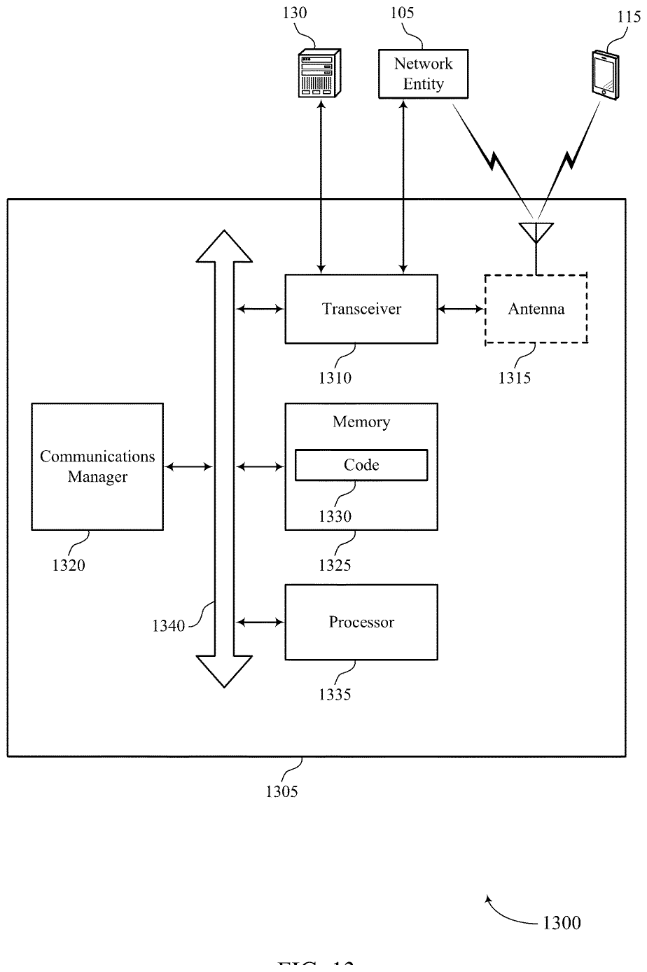

FIG. 13 illustrates a diagram of a system 1300 including a device 1305 that supports techniques for obtaining spatial information with a sparse antenna array in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may include, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for obtaining spatial information with a sparse antenna array). For example, the device 1305 or a component of the device 1305 may include a processor 1335 and memory 1325 coupled with the processor 1335, the processor 1335 and memory 1325 configured to perform various functions described herein.

The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components.

For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity (e.g., the device 1305) in accordance with examples as disclosed herein. For example, the communications manager 1320 may be configured as or otherwise support a means for transmitting, to a UE, a set of downlink reference signals using a set of antenna elements of a sparse antenna array associated with the network entity. Each antenna element of the set of antenna elements corresponding to an antenna element index of a set of antenna element indices associated with the set of antenna elements of the sparse antenna array. The communications manager 1320 may be configured as or otherwise support a means for receiving, from the UE, a report indicating a transformed set of spatial lags associated with the set of antenna elements of the sparse antenna array. Each spatial lag of the transformed set of spatial lags corresponding to a spatial lag index of a set of spatial lag indices associated with the set of antenna elements of the sparse antenna array. The communications manager 1320 may be configured as or otherwise support a means for determining spatial information based on the transformed set of spatial lags associated with the set of antenna elements of the sparse antenna array. The communications manager 1320 may be configured as or otherwise support a means for adjusting one or more parameters associated with the set of antenna elements of the sparse antenna array associated with the network entity based on determining the spatial information.

By including or configuring the communications manager 1320 in accordance with examples as described herein, the device 1305 may support techniques for improved communication reliability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for obtaining spatial information with a sparse antenna array as described herein, or the processor 1335 and the memory 1325 may be otherwise configured to perform or support such operations.

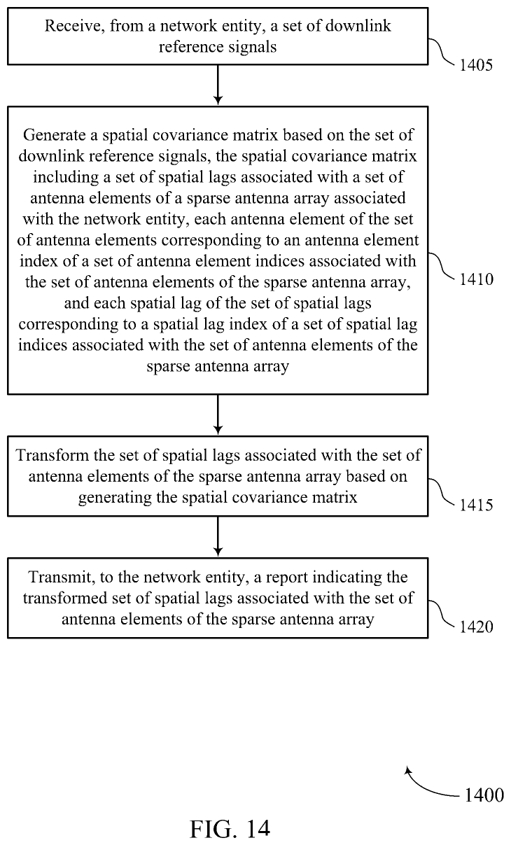

FIG. 14 illustrates a flowchart showing a method 1400 that supports techniques for obtaining spatial information with a sparse antenna array in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a set of downlink reference signals. The operations of 1405 may be performed in accordance with examples as disclosed herein. In some examples, aspects of the operations of 1405 may be performed by a reference signal component 825 as described with reference to FIG. 8.

At 1410, the method may include generating a spatial covariance matrix based on the set of downlink reference signals, the spatial covariance matrix including a set of spatial lags associated with a set of antenna elements of a sparse antenna array associated with the network entity, each antenna element of the set of antenna elements corresponding to an antenna element index of a set of antenna element indices associated with the set of antenna elements of the sparse antenna array, and each spatial lag of the set of spatial lags corresponding to a spatial lag index of a set of spatial lag indices associated with the set of antenna elements of the sparse antenna array. The operations of 1410 may be performed in accordance with examples as disclosed herein. In some examples, aspects of the operations of 1410 may be performed by a matrix component 830 as described with reference to FIG. 8.

At 1415, the method may include transforming the set of spatial lags associated with the set of antenna elements of the sparse antenna array based on generating the spatial covariance matrix. The operations of 1415 may be performed in accordance with examples as disclosed herein. In some examples, aspects of the operations of 1415 may be performed by a transform component 835 as described with reference to FIG. 8.

At 1420, the method may include transmitting, to the network entity, a report indicating the transformed set of spatial lags associated with the set of antenna elements of the sparse antenna array. The operations of 1420 may be performed in accordance with examples as disclosed herein. In some examples, aspects of the operations of 1420 may be performed by a report component 840 as described with reference to FIG. 8.

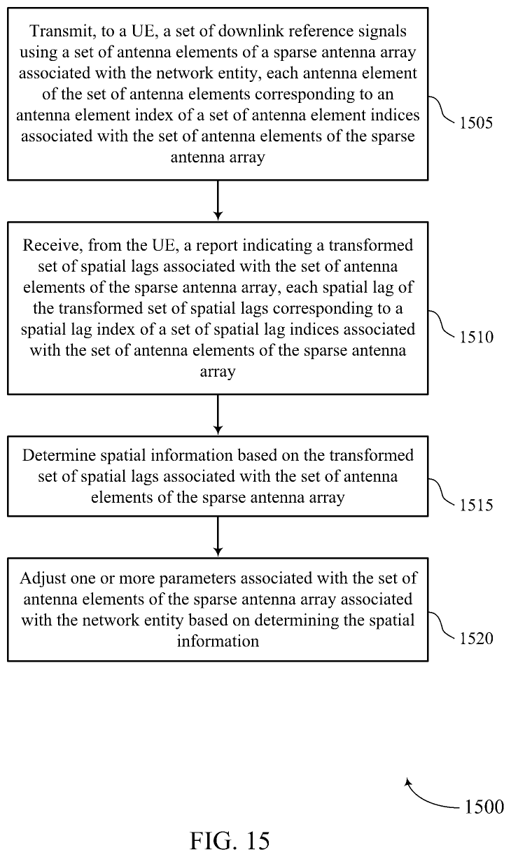

FIG. 15 illustrates a flowchart showing a method 1500 that supports techniques for obtaining spatial information with a sparse antenna array in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, a set of downlink reference signals using a set of antenna elements of a sparse antenna array associated with the network entity, each antenna element of the set of antenna elements corresponding to an antenna element index of a set of antenna element indices associated with the set of antenna elements of the sparse antenna array. The operations of 1505 may be performed in accordance with examples as disclosed herein. In some examples, aspects of the operations of 1505 may be performed by a reference signal component 1225 as described with reference to FIG. 12.

At 1510, the method may include receiving, from the UE, a report indicating a transformed set of spatial lags associated with the set of antenna elements of the sparse antenna array, each spatial lag of the transformed set of spatial lags corresponding to a spatial lag index of a set of spatial lag indices associated with the set of antenna elements of the sparse antenna array. The operations of 1510 may be performed in accordance with examples as disclosed herein. In some examples, aspects of the operations of 1510 may be performed by a report component 1230 as described with reference to FIG. 12.

At 1515, the method may include determining spatial information based on the transformed set of spatial lags associated with the set of antenna elements of the sparse antenna array. The operations of 1515 may be performed in accordance with examples as disclosed herein. In some examples, aspects of the operations of 1515 may be performed by a spatial component 1235 as described with reference to FIG. 12.

At 1520, the method may include adjusting one or more parameters associated with the set of antenna elements of the sparse antenna array associated with the network entity based on determining the spatial information. The operations of 1520 may be performed in accordance with examples as disclosed herein. In some examples, aspects of the operations of 1520 may be performed by a parameter component 1240 as described with reference to FIG. 12.

The following provides an overview of aspects of the present disclosure:

Aspect 1: A method for wireless communication at a UE, comprising: receiving, from a network entity, a set of downlink reference signals; generating a spatial covariance matrix based at least in part on the set of downlink reference signals, the spatial covariance matrix comprising a set of spatial lags associated with a set of antenna elements of a sparse antenna array associated with the network entity, each antenna element of the set of antenna elements corresponding to an antenna element index of a set of antenna element indices associated with the set of antenna elements of the sparse antenna array, and each spatial lag of the set of spatial lags corresponding to a spatial lag index of a set of spatial lag indices associated with the set of antenna elements of the sparse antenna array; transforming the set of spatial lags associated with the set of antenna elements of the sparse antenna array based at least in part on generating the spatial covariance matrix; and transmitting, to the network entity, a report indicating the transformed set of spatial lags associated with the set of antenna elements of the sparse antenna array.

Aspect 2: The method of aspect 1, further comprising: performing a set of downlink reference signal measurements based at least in part on the set of downlink reference signals, wherein the set of spatial lags are associated with the set of downlink reference signal measurements, and wherein generating the spatial covariance matrix is based at least in part on the set of downlink reference signals, the set of downlink reference signal measurements, or both.

Aspect 3: The method of aspect 2, further comprising: determining a covariance of each downlink reference signal measurement of the set of downlink reference signal measurements based at least in part on performing the set of downlink reference signal measurements, wherein generating the spatial covariance matrix is based at least in part on determining the covariance of each downlink reference signal measurement of the set of downlink reference signal measurements.

Aspect 4: The method of any of aspects 1 through 3, wherein a subset of spatial lags of the set of spatial lags correspond to a same spatial lag index of the set of spatial lag indices.

Aspect 5: The method of aspect 4, wherein the set of spatial lags comprises the subset of spatial lags, and wherein transforming the set of spatial lags associated with the set of antenna elements of the sparse antenna array comprises: averaging the subset of spatial lags based at least in part on the subset of spatial lags of the set of spatial lags corresponding to the same spatial lag index of the set of spatial lag indices.

Aspect 6: The method of any of aspects 1 through 5, wherein a set of diagonal entries associated with the spatial covariance matrix corresponds to a null spatial lag index of the set of spatial lag indices.

Aspect 7: The method of aspect 6, wherein transforming the set of spatial lags associated with the set of antenna elements of the sparse antenna array comprises: averaging the set of diagonal entries associated with the spatial covariance matrix based at least in part on the null spatial lag index of the set of spatial lag indices.

Aspect 8: The method of any of aspects 1 through 7, wherein transforming the set of spatial lags associated with the set of antenna elements of the sparse antenna array comprises: normalizing the set of spatial lags associated with the set of antenna elements of the sparse antenna array based at least in part on a quotient of each spatial lag index of the set of spatial lag indices and a null spatial lag index of the set of spatial lag indices.

Aspect 9: The method of any of aspects 1 through 8, further comprising: determining the set of spatial lags associated with the set of antenna elements of the sparse antenna array based at least in part on an absolute difference between antenna element indices of the set of antenna element indices associated with the set of antenna elements of the sparse antenna array and spatial lag indices of the set of spatial lag indices associated with the set of antenna elements of the sparse antenna array, wherein transforming the set of spatial lags associated with the set of antenna elements of the sparse antenna array is based at least in part on determining the set of spatial lags associated with the set of antenna elements of the sparse antenna array.

Aspect 10: The method of aspect 9, wherein the set of spatial lags associated with the set of antenna elements of the sparse antenna array comprises a contiguous subset of spatial lag indices associated with the set of spatial lag indices.

Aspect 11: The method of aspect 10, further comprising: determining the contiguous subset of spatial lag indices associated with the set of spatial lag indices based at least in part on a threshold spatial lag index and on a spacing parameter associated with the spatial lag indices of the set of spatial lag indices.

Aspect 12: The method of any of aspects 1 through 11, wherein the report indicating the transformed set of spatial lags associated with the set of antenna elements of the sparse antenna array comprises an upper triangular portion of the spatial covariance matrix.

Aspect 13: The method of any of aspects 1 through 12, wherein the report indicating the transformed set of spatial lags associated with the set of antenna elements of the sparse antenna array comprises a lower triangular portion of the spatial covariance matrix, or the report indicating the transformed set of spatial lags associated with the set of antenna elements of the sparse antenna array comprises a subset of the transformed set of spatial lags associated with the set of antenna elements of the sparse antenna array, or both.

Aspect 14: The method of any of aspects 1 through 13, wherein the report indicating the transformed set of spatial lags associated with the set of antenna elements of the sparse antenna array comprises a subset of the transformed set of spatial lags associated with the set of antenna elements of the sparse antenna array.

Aspect 15: The method of any of aspects 1 through 14, further comprising: receiving, from the network entity, an indication of the set of spatial lag indices associated with the set of antenna elements of the sparse antenna array, wherein generating the spatial covariance matrix is based at least in part on transmitting, to the UE, the indication of the set of spatial lag indices associated with the set of antenna elements of the sparse antenna array.

Aspect 16: The method of any of aspects 1 through 15, wherein the set of spatial lags associated with the set of antenna elements of the sparse antenna array corresponds to one or more dimensional coordinates associated with the sparse antenna array.

Aspect 17: The method of any of aspects 1 through 16, wherein the set of spatial lag indices associated with the set of antenna elements of the sparse antenna array comprises a positive set of spatial lag indices.

Aspect 18: The method of any of aspects 1 through 17, wherein receiving, from the network entity, the set of downlink reference signals comprises: receiving, from the network entity, the set of downlink reference signals over a set of resource blocks, wherein the set of resource blocks comprises a set of slots.

Aspect 19: The method of any of aspects 1 through 18, wherein the spatial covariance matrix comprises a Hermitian matrix.

Aspect 20: The method of any of aspects 1 through 19, wherein the sparse antenna array is associated with an antenna, the antenna comprises an antenna polarization, and generating the spatial covariance matrix is based at least in part on the antenna polarization.

Aspect 21: A method for wireless communication at a network entity, comprising: transmitting, to a UE, a set of downlink reference signals using a set of antenna elements of a sparse antenna array associated with the network entity, each antenna element of the set of antenna elements corresponding to an antenna element index of a set of antenna element indices associated with the set of antenna elements of the sparse antenna array; receiving, from the UE, a report indicating a transformed set of spatial lags associated with the set of antenna elements of the sparse antenna array, each spatial lag of the transformed set of spatial lags corresponding to a spatial lag index of a set of spatial lag indices associated with the set of antenna elements of the sparse antenna array; determining spatial information based at least in part on the transformed set of spatial lags associated with the set of antenna elements of the sparse antenna array; and adjusting one or more parameters associated with the set of antenna elements of the sparse antenna array associated with the network entity based at least in part on determining the spatial information.

Aspect 22: The method of aspect 21, further comprising: transmitting, to the UE, an indication of the set of spatial lag indices associated with the set of antenna elements of the sparse antenna array, wherein receiving, from the UE, the report indicating the transformed set of spatial lags associated with the set of antenna elements of the sparse antenna array is based at least in part on transmitting, to the UE, the indication of the set of spatial lag indices associated with the set of antenna elements of the sparse antenna array.

Aspect 23: The method of any of aspects 21 through 22, wherein the transformed set of spatial lags associated with the set of antenna elements of the sparse antenna array comprises an averaged set of spatial lags associated with the set of antenna elements of the sparse antenna array.

Aspect 24: The method of any of aspects 21 through 23, wherein the transformed set of spatial lags associated with the set of antenna elements of the sparse antenna array comprises a normalized set of spatial lags associated with the set of antenna elements of the sparse antenna array.

Aspect 25: The method of any of aspects 21 through 24, wherein the report indicating the transformed set of spatial lags associated with the set of antenna elements of the sparse antenna array comprises an upper triangular portion of a spatial covariance matrix.

Aspect 26: The method of any of aspects 21 through 25, wherein the report indicating the transformed set of spatial lags associated with the set of antenna elements of the sparse antenna array comprises a lower triangular portion of a spatial covariance matrix.

Aspect 27: The method of any of aspects 21 through 26, wherein the report indicating the transformed set of spatial lags associated with the set of antenna elements of the sparse antenna array comprises a subset of the transformed set of spatial lags associated with the set of antenna elements of the sparse antenna array.

Aspect 28: The method of any of aspects 21 through 27, wherein the transformed set of spatial lags associated with the set of antenna elements of the sparse antenna array corresponds to one or more dimensional coordinates associated with the sparse antenna array.

Aspect 29: An apparatus for wireless communication at a UE, comprising a processor; memory coupled with the processor; and instructions stored in the memory and executable by the processor to cause the apparatus to perform a method of any of aspects 1 through 20.

Aspect 30: An apparatus for wireless communication at a UE, comprising at least one means for performing a method of any of aspects 1 through 20.

Aspect 31: A non-transitory computer-readable medium storing code for wireless communication at a UE, the code comprising instructions executable by a processor to perform a method of any of aspects 1 through 20.

Aspect 32: An apparatus for wireless communication at a network entity, comprising a processor; memory coupled with the processor; and instructions stored in the memory and executable by the processor to cause the apparatus to perform a method of any of aspects 21 through 28.

Aspect 33: An apparatus for wireless communication at a network entity, comprising at least one means for performing a method of any of aspects 21 through 28.

Aspect 34: A non-transitory computer-readable medium storing code for wireless communication at a network entity, the code comprising instructions executable by a processor to perform a method of any of aspects 21 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
receiving, from a network entity, a set of downlink reference signals;
generating a spatial covariance matrix based at least in part on the set of downlink reference signals, the spatial covariance matrix comprising a set of spatial lags associated with a set of antenna elements of a sparse antenna array associated with the network entity, each antenna element of the set of antenna elements corresponding to an antenna element index of a set of antenna element indices associated with the set of antenna elements of the sparse antenna array, and each spatial lag of the set of spatial lags corresponding to a spatial lag index of a set of spatial lag indices associated with the set of antenna elements of the sparse antenna array;
transforming the set of spatial lags associated with the set of antenna elements of the sparse antenna array based at least in part on generating the spatial covariance matrix; and
transmitting, to the network entity, a report indicating the transformed set of spatial lags associated with the set of antenna elements of the sparse antenna array.

2. The method of claim 1, further comprising:
performing a set of downlink reference signal measurements based at least in part on the set of downlink reference signals,
wherein the set of spatial lags are associated with the set of downlink reference signal measurements, and
wherein generating the spatial covariance matrix is based at least in part on the set of downlink reference signals, the set of downlink reference signal measurements, or both.

3. The method of claim 2, further comprising:
determining a covariance of each downlink reference signal measurement of the set of downlink reference signal measurements based at least in part on performing the set of downlink reference signal measurements,
wherein generating the spatial covariance matrix is based at least in part on determining the covariance of each downlink reference signal measurement of the set of downlink reference signal measurements.

4. The method of claim 1, wherein a subset of spatial lags of the set of spatial lags correspond to a same spatial lag index of the set of spatial lag indices.

5. The method of claim 4, wherein the set of spatial lags comprises the subset of spatial lags, and wherein transforming the set of spatial lags associated with the set of antenna elements of the sparse antenna array comprises:
averaging the subset of spatial lags based at least in part on the subset of spatial lags of the set of spatial lags corresponding to the same spatial lag index of the set of spatial lag indices.

6. The method of claim 1, wherein a set of diagonal entries associated with the spatial covariance matrix corresponds to a null spatial lag index of the set of spatial lag indices.

7. The method of claim 6, wherein transforming the set of spatial lags associated with the set of antenna elements of the sparse antenna array comprises:
averaging the set of diagonal entries associated with the spatial covariance matrix based at least in part on the null spatial lag index of the set of spatial lag indices.

8. The method of claim 1, wherein transforming the set of spatial lags associated with the set of antenna elements of the sparse antenna array comprises:
normalizing the set of spatial lags associated with the set of antenna elements of the sparse antenna array based at least in part on a quotient of each spatial lag index of the set of spatial lag indices and a null spatial lag index of the set of spatial lag indices.

9. The method of claim 1, further comprising:
determining the set of spatial lags associated with the set of antenna elements of the sparse antenna array based at least in part on an absolute difference between antenna element indices of the set of antenna element indices associated with the set of antenna elements of the sparse antenna array and spatial lag indices of the set of spatial lag indices associated with the set of antenna elements of the sparse antenna array,
wherein transforming the set of spatial lags associated with the set of antenna elements of the sparse antenna array is based at least in part on determining the set of spatial lags associated with the set of antenna elements of the sparse antenna array.

10. The method of claim 9, wherein the set of spatial lags associated with the set of antenna elements of the sparse antenna array comprises a contiguous subset of spatial lag indices associated with the set of spatial lag indices.

11. The method of claim 10, further comprising:
determining the contiguous subset of spatial lag indices associated with the set of spatial lag indices based at least in part on a threshold spatial lag index and on a spacing parameter associated with the spatial lag indices of the set of spatial lag indices.

12. The method of claim 1, wherein the report indicating the transformed set of spatial lags associated with the set of antenna elements of the sparse antenna array comprises an upper triangular portion of the spatial covariance matrix.

13. The method of claim 1, wherein the report indicating the transformed set of spatial lags associated with the set of antenna elements of the sparse antenna array comprises a lower triangular portion of the spatial covariance matrix, or the report indicating the transformed set of spatial lags associated with the set of antenna elements of the sparse antenna array comprises a subset of the transformed set of spatial lags associated with the set of antenna elements of the sparse antenna array, or both.

14. The method of claim 1, wherein the report indicating the transformed set of spatial lags associated with the set of antenna elements of the sparse antenna array comprises a subset of the transformed set of spatial lags associated with the set of antenna elements of the sparse antenna array.

15.-20. (canceled)

21. A method for wireless communication at a network entity, comprising:
transmitting, to a user equipment (UE), a set of downlink reference signals using a set of antenna elements of a sparse antenna array associated with the network entity, each antenna element of the set of antenna elements corresponding to an antenna element index of a set of antenna element indices associated with the set of antenna elements of the sparse antenna array;
receiving, from the UE, a report indicating a transformed set of spatial lags associated with the set of antenna elements of the sparse antenna array, each spatial lag of the transformed set of spatial lags corresponding to a spatial lag index of a set of spatial lag indices associated with the set of antenna elements of the sparse antenna array;
determining spatial information based at least in part on the transformed set of spatial lags associated with the set of antenna elements of the sparse antenna array; and
adjusting one or more parameters associated with the set of antenna elements of the sparse antenna array associated with the network entity based at least in part on determining the spatial information.

22. The method of claim 21, further comprising:
transmitting, to the UE, an indication of the set of spatial lag indices associated with the set of antenna elements of the sparse antenna array,
wherein receiving, from the UE, the report indicating the transformed set of spatial lags associated with the set of antenna elements of the sparse antenna array is based at least in part on transmitting, to the UE, the indication of the set of spatial lag indices associated with the set of antenna elements of the sparse antenna array.

23. The method of claim 21, wherein the transformed set of spatial lags associated with the set of antenna elements of the sparse antenna array comprises an averaged or a normalized set of spatial lags associated with the set of antenna elements of the sparse antenna array.

24. (canceled)

25. The method of claim 21, wherein the report indicating the transformed set of spatial lags associated with the set of antenna elements of the sparse antenna array comprises an upper or a lower triangular portion of a spatial covariance matrix.

26. (canceled)

27. The method of claim 21, wherein the report indicating the transformed set of spatial lags associated with the set of antenna elements of the sparse antenna array comprises a subset of the transformed set of spatial lags associated with the set of antenna elements of the sparse antenna array.

28. (canceled)

29. An apparatus for wireless communication, comprising:
a processor;
memory coupled with the processor; and
instructions stored in the memory and executable by the processor to cause the apparatus to:
receive, from a network entity, a set of downlink reference signals;
generate a spatial covariance matrix based at least in part on the set of downlink reference signals, the spatial covariance matrix comprising a set of spatial lags associated with a set of antenna elements of a sparse antenna array associated with the network entity, each antenna element of the set of antenna elements corresponding to an antenna element index of a set of antenna element indices associated with the set of antenna elements of the sparse antenna array, and each spatial lag of the set of spatial lags corresponding to a spatial lag index of a set of spatial lag indices associated with the set of antenna elements of the sparse antenna array;
transform the set of spatial lags associated with the set of antenna elements of the sparse antenna array based at least in part on generating the spatial covariance matrix; and
transmit, to the network entity, a report indicating the transformed set of spatial lags associated with the set of antenna elements of the sparse antenna array.

30. (canceled)
